(19) United States
(12) Patent Application Publication
(10) Pub. No.: US 2025/0017206 A1
(43) Pub. Date: Jan. 16, 2025

(54) METHODS FOR PREVENTING OR REDUCING BACTERIAL INFECTION OF PLANT SEEDS

(71) Applicant: VIRGINIA TECH INTELLECTUAL PROPERTIES, INC., Blacksburg, VA (US)

(72) Inventors: Gregory E. Welbaum, Blacksburg, VA (US); Bingyu Zhao, Blacksburg, VA (US); Merve Kiremit, Blacksburg, VA (US)

(21) Appl. No.: 18/894,249

(22) Filed: Sep. 24, 2024

Related U.S. Application Data
(63) Continuation-in-part of application No. PCT/US2023/064855, filed on Mar. 23, 2023.
(60) Provisional application No. 63/323,211, filed on Mar. 24, 2022.

(51) Int. Cl. A01N 43/16; A01N 43/40; A01N 43/90; A01N 65/08; A01P 1/00

(52) U.S. Cl. CPC A01N 43/16; A01N 43/40; A01N 43/90; A01N 65/08; A01P 1/00

(57) ABSTRACT

Described herein are methods preventing or reducing a bacterial infection on a plant seed. In one aspect, the method involves applying to the plant seed epigallocatechin-3 gallate, catechin, epicatechin, or any combination thereof. In one aspect, a mixture comprising epigallocatechin-3 gallate, catechin, and epicatechin is applied to the plant seed. In another aspect, green tea is applied to the plant seed. In other aspects, epigallocatechin-3 gallate, catechin, epicatechin, or any combination thereof is applied to plant seed in combination with an antibiotic, where a synergistic effect is observed. In other aspects, epigallocatechin-3 gallate, catechin, epicatechin, or any combination thereof is added to soil before and/or after the seed is planted in the soil.

### CROSS-REFERENCE TO RELATED APPLICATIONS

This application is a continuation-in-part of International Application No. PCT/US2023/064855 filed on Mar. 23, 2023, which claims the benefit of and priority to co-pending U.S. Provisional Patent Application No. 63/323,211, filed on Mar. 24, 2022, the contents of which are incorporated by reference herein in their entirety.

### STATEMENT OF GOVERNMENT INTEREST

This invention was made with government support under Grant No. IS-5023-17C awarded by the Binational Agricultural Research and Development Fund. This invention also was made with government support under Grant No. 20161213-Kiremit-EN awarded by the Fulbright Fellowship. The government has certain rights in the invention.

### BACKGROUND

Bacterial fruit blotch disease of cucurbits is a seed-borne and major seed-transmitted disease. Bacterial fruit blotch (BFB) disease of cucurbits is an economically devastating plant disease responsible for an estimated loss of up to $450M on watermelon crops and $75M to the seed and transplant industries since 1996. BFB is caused by Acidovorax citrulli and is transmitted by infected cucurbit seeds. Despite ongoing research for disease resistance, there are no resistant cultivars. Currently, there is no effective disease management strategy. Because there is no effective control, the seed industry has zero-tolerance for infected seeds in commercial lots.

BFB is a gram-negative bacteria that was previously identified as a pseudomonad under the name “Pseudomonas pseudoalcaligenes subsp. citrulli” due to morphological similarities between the two species. Like pseudomonads, A. citrulli is rod-shaped bacteria, has single polar flagella, and uses the type Ill secretion system (T3SS). Willems et al. (1992) re-classified the phytopathogen as Acidovorax citrulli after a thorough investigation of DNA-rRNA hybridizations of the species' rRNA complex. A. citrulli has three identified strain groups. Group-I is moderately to highly aggressive on a wide range of cucurbits but most common on melon (Cucumis melo L.). Group-II is known to be highly aggressive on watermelon (Citrullus lanatus L.) and mildly so on other cucurbit species. The recently identified group-III is known to be weakly virulent on melon, watermelon, pumpkin, and has low epidemic potential. M6 and AAC00-1 strains are representative strains from Group-I and II, respectively.

Dutta et al. (2012) identified two types of seed transmission of BFB disease. Bacteria can reside on the seed coat. Seed coat infection most often occurs as bacteria from infected fruit pericarp tissue migrate to seeds in the central fruit cavity. Therefore, seed coat transmission is a repercussion of fruit infection. The other type of seed transmission is embryo transmission. Dutta et al., 2012 demonstrated that infected pollen may deliver BFB to the embryo sac, infecting the developing embryo inside. Embryo infection varies from seed-to-seed in the same fruit depending on whether BFB migrates with pollen tube growth during fertilization. With pericarp infection and depending on the severity, it is likely that coats of most seeds in an infected fruit will transmit BFB. Both embryo and coat infection may occur in the same seed if BFB is transmitted through the pericarp and at the same time BFB migrates to the embryo through the pollen tube.

Previous studies with Cucumis spp. show that a single layer of endosperm with suberized cell walls protects the sensitive developing embryo inside after roughly 35 days after anthesis from the harsh breakdown products of fruit decomposition. As melon fruits senesce a harsh osmotic environment develops and sugars are fermented to alcohols. The endosperm in cucurbits and certain other species has evolved to protect the sensitive embryo inside from this harsh environment (Yim and Bradford, 1998; Welbaum and Bradford, 1990a). This resilient endosperm forms an osmotic barrier that acts like a molecular sieve surrounding the embryo preventing migration of bacteria like BFB from the seed coat to the embryo. In the case of BFB transmission, this means that seed coat infection does not spread to the embryo and vice versa because such movement is blocked by the semipermeable endosperm layer protecting the embryo just below the seed coat. Interestingly the endosperm tissue is not a barrier to water, so only diffusion of large molecules and bacterial are blocked (Welbaum and Bradford, 1990a). Germination of these seeds does not occur until the endosperm envelope is enzymatically ruptured allowing radicle protrusion. (Welbaum et al., 1998; Welbaum and Bradford, 1990b).

A. citrulli has been observed to survive for more than 34 years in stored melon and watermelon seeds (Dutta 2016). A primary preventative strategy against BFB could be to target the source, the A. citrulli contaminated seeds by removing them from lots or with treatments to kill bacteria. Various seed treatments have been used against BFB, but their effectiveness is limited. These treatments include: soaking infected seeds in streptomycin for 16 h 1 mg/ml (Sowell 1979), hot water treatment at 50° C. for 20-30 min (Wall 1989), peroxyacetic acid treatment at 1,600 μg/ml and higher for 30 min or hydrochloric acid treatments at 10,000 μg/ml (Hopkins 2003), acidic electrolyzed water treatment for 30 min (Feng et al. 2009), dry heat treatment higher than 90° C. for seven days (Kubota 2012) and cinnamon oil treatment (Choi 2016). However, except for peroxyacetic/peracetic acid, none of these treatments are widely used commercially for various reasons despite their reported success. Peroxyacetic/peracetic acid is used commercially and accepted by the National Organic Program (NOP); however, the chemical in low concentrations can irritate skin and eyes, as well as cause throat and breathing difficulties, and in concentrated form, it can cause severe eye and skin damage. Therefore, its usage requires additional equipment, disposal protocols which are not practical. According to Choi et al. (2016), 32 essential oils were compared for their inhibitory effects against A. citrulli, among the various components of cinnamon oil, benzaldehyde and cinnamaldehyde exhibited antibacterial activities against strain AAC00-1. However, aside from their costliness essential oil treatment could potentially decrease storage and inhibit germination. More conventional treatments, particularly hot water and dry heat treatments, adversely affect the seed quality by aging seeds. Because a 50° C. hot water treatment causes accelerating seed aging, viability and vigor are reduced. Therefore, hot water treatment is not used because it may damage seed and reduce germination. Hot water is only marginally effective at controlling BFB.

### SUMMARY

Described herein are methods preventing or reducing a bacterial infection on a plant seed. In one aspect, the method involves applying to the plant seed epigallocatechin-3 gallate, catechin, epicatechin, or any combination thereof. In one aspect, a mixture comprising epigallocatechin-3 gallate, catechin, and epicatechin is applied to the plant seed. In another aspect, green tea is applied to the plant seed. In other aspects, epigallocatechin-3 gallate, catechin, epicatechin, or any combination thereof is applied to plant seed in combination with an antibiotic, where a synergistic effect is observed. In other aspects, epigallocatechin-3 gallate, catechin, epicatechin, or any combination thereof is added to soil before and/or after the seed is planted in the soil.

The advantages of the invention will be set forth in part in the description which follows, and in part will be obvious from the description or may be learned by practice of the aspects described below. The advantages described below will be realized and attained by means of the elements and combinations particularly pointed out in the appended claims. It is to be understood that both the foregoing general description and the following detailed description are exemplary and explanatory only and is not restrictive.

### BRIEF DESCRIPTION OF THE DRAWINGS

The accompanying drawings, which are incorporated in and constitute a part of this specification, illustrate several aspects described below:

FIG. 1 shows the standard curve of HPLC reference compounds' gradient table. On the x axis concentration in mg mL⁻¹, on the y axis peak area as calculated from the chromatograph.

FIG. 2 shows preliminary experiments comparing A. citrulli growth with green or black tea on LB agar media. Three replicates (left to right on each plate) of 5 μL each of AA000-1 dilutions of 0.1, 0.01, 0.001 from a stock solution of OD₆₀₀:1.0 grown vertically on LB agar plates. The same stock solution of tea preparation with optical density (390 nm) of 1.0 was added. Row one: LB agar medium containing (a) 5% (b) 10%, (c) 20% black tea. Row two: LB agar medium containing (d) 5%, (e) 10%, (f) 20% green tea. Green tea inhibited some A. citrulli solutions but black tea did not.

FIG. 3 shows preliminary experiments comparing A. citrulli growth with tea treatments and with and without antibiotics. first row: Three replicates (left to right on each plate) of 5 μL each containing AAC00-1 1.0, 0.1, 0.01, 0.001 dilutions of a bacterial stock solution inoculum with OD₆₀₀: 1.0 grown on LB agar plates with (a) 5%, (b) 10%, (c) 20% green tea; second row additionally containing rifampicin 100 μg/mL. 10% green tea and rifampicin 100 μg/mL combined in the same media had a synergistic effect reducing growth of A. citrulli more than green tea alone.

FIG. 4 shows bacterial colony growth in response to caffeine and catechin treatments. 5 μL of A. citrulli strains M6, AAC00-1, aacI and aacR inoculation solutions OD₆₀₀:1.0, 0.5, 0.1, 0.01, 0.001 were grown vertically on LB agar medium containing 10% caffeine (top row of plates) or catechin (bottom row) (From left to right final concentration in rows within plates were 0.01, 0.1, 1, 10 mM). All plates contained selective antibiotic rifampicin 100 μg/mL. Bacterial growth was inhibited by 1 and 10 mM catechin added to LB media. Only 10 mM caffeine inhibited lower BFB OD₆₀₀ nm 0.01 and 0.001 solutions. 10 mM catechin completely inhibited bacterial growth and 1 mM catechin inhibited some lower density colonies of bacteria. Only 10 mM caffeine reduced growth of lowest density bacterial colonies.

FIG. 5 shows the three factor ANOVA comparison of the preliminary experiments of bacterial colony growth inhibition effects of 10% catechin and caffeine (stock solution: 0.1 mM, 1 mM, 10 mM, 100 mM) against AAC00-1, M6, aacI, and aacR strains. Control 1 was LB agar growth medium and control 2 was LB agar growth medium containing 10% sterilized water. Final concentration of 10 mM catechin inhibited growth of all bacterial strains. Dots show outliers.

FIG. 6 shows the three factor ANOVA comparison of the bacterial colony growth inhibition effects of loose-leaf green tea, green tea dry extract and EGC. H_gt green tea (OD₃₉₀:0.5, 1.0, 2.0, 4.0), green tea dry extract (Sigma Aldrich, 0.5-1-2 mg:10 mL) and EGC (0.33 mM, 0.5 mM, 1 mM) tested for inhibition of AA000-1, M6, aacI, and aacR strains (OD₆₀₀:1.0, 0.1, 0.01, 0.001). H_gt green tea OD 4.0, and green tea dry extract 1 and 2 mg/10 mL inhibited all bacterial growth. 1 mM EGC, H_gt green tea OD 2.0 inhibited bacterial growth on 0.1 dilution of bacteria.

FIG. 7 shows the two factor ANOVA comparison of the bacterial colony growth inhibition effects of catechin concentrations (0.1 mM, 1 mM, 10 mM) against AAC00-1 strain. Yes and no plots were divided according to the usage of selective antibiotic rifampicin 100 μg/mL in the growth medium. No difference was observed with the antibiotic presence. 10 mM catechin inhibited bacterial growth as opposed to other concentrations.

FIG. 8 shows the three factor ANOVA comparison of the bacterial colony growth inhibition effects of catechins. AAC00-1 1.0, 0.1, 0.01, 0.001 dilutions of a bacterial stock solution inoculum with OD₆₀₀: 1.0 were grown on LB agar media containing C (5-10-15 mM), EC, (0.5-1-1.5 mM), ECG (0.5-1-1.5 mM), or EGC (0.5-1-1.5 mM). 5-10-15 mMs of catechin (C) inhibited all bacterial growth. 1.5 mM epicatechin (EC) and 1.5 mM epicatechin gallate (ECG) inhibited all bacterial growth. Epigallocatechin (EGC) showed no inhibition.

FIG. 9 shows bacterial colony growth in response to powdered green and organic black tea treatments on the LB agar growth medium. 5 μL of inoculum of wt M6, wt AAC_001, aacI, aacR with 1.0, 0.5, 0.1, 0.01, 0.001 dilutions of a bacterial stock solution inoculum with OD₆₀₀: 1.0 were grown on 10% powder green (P_gt) or 10% loose leaf organic black (P_ogt) tea extract with OD₃₉₀: 0.1, 0.5, 1.0, 2.0. 3.0, 4.0 containing LB agar plates. All plates contained rifampicin 100 μg/mL. Powder green tea and organic black tea showed similar inhibition results. At 4.0 tea OD, black tea showed more inhibition than powder green tea.

FIG. 10 shows bacterial colony growth in response to different commercial brands of tea treatments on the LB agar growth medium. Right Side. Bacterial concentration dilutions 1.0, 0.5, 0.1, 0.01, 0.001 of A. citrulli stock solution OD₆₀₀: 1.0, ordered vertically from most concentrated to least. X-axis. All LB agar media contained 10% tea of four concentrations (OD₃₉₀: 0.5, 1.0, 2.0, 3.0, 4.0) and rifampicin 100 μg/mL. Left Side commercial brands of tea a) C_bt (black tea), b) P_obt (organic black tea), c) P_ogt (organic green tea), d) P_gt (powder green tea), e) H_gt (green tea), f) W_gt (green tea), g) Y_gt (green tea). Reduced Bacterial growth decreased with the increasing of tea concentration except for C_bt (black tea). Green tea more effectively inhibited A. citrulli than black. There was significant variation among the antibacterial effects of green tea brands.

FIG. 11 shows three factor ANOVA data visualization of the coinhibition effects of selective antibiotic and tea against M6 bacterial colony growth. Left panel, growth medium containing rifampicin 100 μg/mL (selective antibiotic). Right panel, no antibiotics in growth medium. a) C_bt (black tea), b) P_obt (organic black tea), c) P_ogt (organic green tea), d) P_gt (green tea), e) H_gt (green tea), f) W_gt (green tea), g) Y_gt (green tea). Tea OD₃₉₀: 0.5, 1.0, 2.0, 3.0, 4.0. Rifampicin increased inhibition when combined with teas.

FIG. 12 shows the three-factor ANOVA data visualization of the coinhibition effects of selective antibiotic and tea against AAC00-1 bacterial colony growth. Left panel, growth medium containing rifampicin 100 μg/mL (selective antibiotic). Right panel, no antibiotics in growth medium. a) C_bt (black tea), b) P_obt (organic black tea), c) P_ogt (organic green tea), d) P_gt (green tea), e) H_gt (green tea), f) W_gt (green tea), g) Y_gt (green tea). Tea OD₃₉₀: 0.5, 1.0, 2.0, 3.0, 4.0. Rifampicin increased inhibition in combination with teas.

FIG. 13 shows the three-factor ANOVA data visualization of the coinhibition effects of selective antibiotic and tea against aacI bacterial colony growth. Left panel, growth medium containing rifampicin 100 μg/mL (selective antibiotic). Right panel, no antibiotics on growth medium. a) C_bt (black tea), b) P_obt (organic black tea), c) P_ogt (organic green tea), d) P_gt (green tea), e) H_gt (green tea), f) W_gt (green tea), g) Y_gt (green tea). Tea OD₃₉₀: 0.5, 1.0, 2.0, 3.0, 4.0. Rifampicin increased inhibition in combination with teas.

FIG. 14 shows the three-factor ANOVA data visualization of the coinhibition effects of selective antibiotic and tea against aacR bacterial colony growth. Left panel, growth medium containing rifampicin 100 μg/mL (selective antibiotic). Right panel, no antibiotics in growth medium. a) C_bt (black tea), b) P_obt (organic black tea), c) P_ogt (organic green tea), d) P_gt (green tea), e) H_gt (green tea), f) W_gt (green tea), g) Y_gt (green tea). Tea OD₃₉₀: 0.5, 1.0, 2.0, 3.0, 4.0. Rifampicin increased inhibition in combination with teas.

FIG. 15 shows bacterial growth in the presence of black tea C_bt brand with or without rifampicin 100 μg/mL in LB agar media. Rifampicin resistant M6, AAC00-1, aacI, aacR strains of A. citrulli after dilutions 1.0, 0.5, 0.1, 0.01, 0.001 dilutions of stock solution OD₆₀₀: 1.0 (Right column). Bacteria were grown in LB media with 10% tea (OD₃₉₀: 0.5, 1.0, 2.0, 3.0, 4.0, X-axis). Top row plates also contained rifampicin 100 μg/mL, while the bottom row of plates contained no antibiotics. Addition of the selective antibiotics had no consistent effect on bacterial growth.

FIG. 16 shows bacterial growth in the presence of P_obt brand organic black tea in LB agar media with or without the selective antibiotic Rifampicin 100 μL. Rifampicin resistant colonies of A. citrulli strains M6, AAC00-1, aacI, aacR were grown on LB agar media. (Right column) An OD₆₀₀: 1.0 bacterial stock solution was diluted 1.0, 0.5, 0.1, 0.01, 0.001 and grown with 10% tea of each of the following dilutions (OD₃₉₀: 0.5, 1.0, 2.0, 3.0, 4.0, X-axis). Top row of plates contained rifampicin 100 μg/mL and bottom row contained no antibiotics. Rifampicin increased inhibition in combination with P_obt brand organic black tea.

FIG. 17 shows bacterial growth in the presence of P_ogt brand organic green tea on LB agar media with or without the selective antibiotic rifampicin 100 μL in LB agar media. Rifampicin resistant colonies of A. citrulli strains M6, AAC00-1, aacI, aacR were grown on LB agar media. (Right column) An OD₆₀₀: 1.0 bacterial stock solution was diluted 1.0, 0.5, 0.1, 0.01, 0.001 and grown with 10% tea of each of the following dilutions (OD₃₉₀: 0.5, 1.0, 2.0, 3.0, 4.0, x-axis). Top row of plates contained rifampicin 100 μg/mL and bottom row contained no antibiotics. Rifampicin increased inhibition in combination with P_ogt brand organic green tea.

FIG. 18 shows bacterial colony growth in the presence of green tea, H_gt brand green tea with or without rifampicin 100 μg/mL in LB agar medium. Rifampicin resistant colonies of A. citrulli strains M6, AAC00-1, aacI, aacR were grown on LB agar media. (Right column) An OD₆₀₀: 1.0 bacterial stock solution was diluted 1.0, 0.5, 0.1, 0.01, 0.001 and grown with 10% tea of each of the following dilutions (OD₃₉a: 0.5, 1.0, 2.0, 3.0, 4.0, x-axis). Top row of plates contained rifampicin 100 μg/mL and bottom row contained no antibiotics. Rifampicin increased inhibition in combination with H_gt brand green tea.

FIG. 19 shows bacterial colony growth in the presence of powdered green tea, P_gt brand with or without Rifampicin 100 μg/mL in LB agar medium. Rifampicin resistant colonies of A. citrulli strains M6, AA000-1, aacI, aacR were grown on LB agar media. (Right column) An OD₆₀₀: 1.0 bacterial stock solution was diluted 1.0, 0.5, 0.1, 0.01, 0.001 and grown with 10% tea of each of the following dilutions (OD₃₉a: 0.5, 1.0, 2.0, 3.0, 4.0, x-axis). Top row of plates contained rifampicin 100 μg/mL and bottom row contained no antibiotics. Rifampicin increased BFB inhibition in combination with powdered green tea, P_gt brand.

FIG. 20 shows bacterial colony growth in presence of W_gt brand of green tea with or without rifampicin 100 μg/mL in LB agar medium. Rifampicin resistant colonies of A. citrulli strains M6, AAC00-1, aacI, aacR were grown on LB agar media. (Right column) An OD₆₀₀: 1.0 bacterial stock solution was diluted 1.0, 0.5, 0.1, 0.01, 0.001 and grown with 10% tea of each of the following dilutions (OD₃₉a: 0.5, 1.0, 2.0, 3.0, 4.0, x-axis). Top row of plates contained rifampicin 100 μg/mL and bottom row contained no antibiotics. Rifampicin increased inhibition in combination with W_gt green tea.

FIG. 21 shows bacterial colony growth in presence of P_ogt organic green tea with or without rifampicin 100 μg/mL in LB agar medium. Rifampicin resistant colonies of A. citrulli strains M6, AAC00-1, aacI, aacR were grown on LB agar media. (Right column) An OD₆₀₀: 1.0 bacterial stock solution was diluted 1.0, 0.5, 0.1, 0.01, 0.001 and grown with 10% tea of each of the following dilutions (OD₃₉a: 0.5, 1.0, 2.0, 3.0, 4.0, x-axis). Top row of plates contained rifampicin 100 μg/mL and bottom row contained no antibiotics. Rifampicin increased inhibition in combination with P_ogt organic green tea.

FIG. 22 shows the bar graph comparison of C, EC, EGCG contents of commercial tea brands via high-performance liquid chromatography (HPLC) analysis. C_bt, P_obt, P_ogt, P_gt, H_gt, W_gt, Y_gt. Below the bar graph C, EC and EGCG concentrations are shown in mg/ml. Highest to lowest catechin content was observed with the following order, W_gt>H_gt>P_ogt>Y_gt>P_obt>P_gt>C_bt. Highest to lowest epicatechin content was observed with the following order, H_gt>Y_gt>P_ogt>P_gt>C_bt>W_gt>P_obt. Highest to lowest epigallocatechin gallate content was observed with the following order, W_gt>H_gt>Y_gt>P_ogt>P_gt>P_obt>C_bt.

FIG. 23 shows field emission scanning electron microscope (FESEM) images of green tea treated bacteria. On the left untreated controls of M6 and AAC00-1 bacteria and on the right 12 h OD₃₉₀: 4.5 green tea treated (Y_gt) wild type M6 and AAC00-1 strains of A. citrulli. With the treatment of green tea, disruption on the cellular wall of bacteria was observed.

FIG. 24A shows the X-ray cross-sectional image of a melon seed showing from outside to seed coat, endosperm, and embryo tissue as. A. citrulli embryo infection damage is visualized in the embryo tissue as irregularly shaped black spots. FIG. 24B shows pericarp infected seed showing fluorescent tagged A. citrulli in the seed coat. The faint fluorescence on the inside of the seed coat is the endosperm cell layer. No fluorescent bacteria are present in the embryo tissue to the right of the seed coat and endosperm.

FIG. 25 shows the detection of GFP signaling A. citrulli in ‘Crimson Sweet’ watermelon seedlings that were previously seed inoculated (M6_GFP OD₆₀₀:1.0, vacuum infiltration). A. Brightfield illumination of cotyledon showing lesioning in cotyledon tip caused by M6 strain of A. citrulli. A′. Same cotyledon under epifluorescence showing GFP expressing A. citrulli on cotyledon tip lesion as well as cotyledon body and root. B. Brightfield illumination of different representative seedling's cotyledon with no apparent tip lesioning. B′. Same cotyledon under epifluorescence showing GFP speckled throughout cotyledon and one small lesion on the upper left-hand portion of the cotyledon. C, D. Significant GFP presence in two different seedling roots. E. Cotyledon of the control plant with no apparent lesion. E′. GFP signal detection on the control's cotyledon. F. Representative image of control plant's root. F′. GFP autofluorescence on the untreated control plant's root.

FIG. 26 shows the detection of GFP signaling A. citrulli in ‘Hales Best Jumbo’ melon seedlings that were previously seed inoculated (M6_GFP OD₆₀₀:1.0 vacuum infiltration). A. Brightfield illumination of cotyledon with no apparent lesioning. A′. Same cotyledon under epifluorescence showing barely detectible GFP in cotyledon (white arrows). B. Brightfield illumination of cotyledon showing small lesion on edge. B′. Same cotyledon under epifluorescence showing minimal GFP at the site of the lesion. C, D. Presence of GFP in two different in seedling roots. E. no lesion showing cotyledons on non-treated control. E′. no autofluorescence on cotyledons of the control. F. Images of control plant's root. F′. GFP autofluorescence of the control's root. Overall GFP signal caused by M6 strain of A. citrulli is less than watermelon cultivar and control shows slight autofluorescence on the roots.

FIG. 27 shows tea treatment reduces and inhibits BFB transmission. Detection of GFP in seedcoat infected (M6_GFP OD₆₀₀:1.0) watermelon seedlings treated with green tea (Y_gt OD₃₉₀:4.0). A. Brightfield illumination of cotyledon with no apparent lesioning. A′. Same cotyledon under epifluorescence showing no evidence of GFP (two small specks at the top of the cotyledon are part of the shiny seed cap, not GFP). B. Brightfield illumination of cotyledon with no apparent lesioning. B′. Same cotyledon under epifluorescence showing very slight GFP on the periphery of the cotyledon (arrow). C, D. GFP presence in two different seedling roots. Possible autofluorescence observed on the roots.

FIG. 28 shows the comparison of the percentage of infection phenotypes (GFP detected in roots; GFP detected in cotyledons; lesions detected in cotyledons) observed in untreated ‘Crimson Sweet’ inoculated with M6_GFP OD₆₀₀:1.0 (blue bars) and ‘Crimson Sweet’ inoculated with M6_GFP OD₆₀₀:1.0 treated with green tea at OD₃₉₀:4.0 (orange bars) seedlings. Green tea treated germinating seeds' roots showed slight autofluorescence and were counted as GFP signal, as well.

FIG. 29 shows the comparison of the percentage of infection phenotypes (GFP detected in roots; GFP detected in cotyledons; lesions detected in cotyledons) in ‘Crimson Sweet’ inoculated with M6_GFP at OD₆₀₀:1.0 treated with green tea at OD₃₉₀:4.0 (blue bars) and ‘Crimson Sweet’ inoculated with M6_GFP at OD₆₀₀:0.001 treated with green tea at OD₃₉₀:4.0 (orange bars).

FIG. 30 shows BFB infected melon seeds.

FIG. 31 shows tea extract (HPGT) effectively reduces the A. citrulli bacterial population in contaminated soil. Bacterial populations were assessed at 0 and 2 days post-inoculation. The blue bar represents the soil treated with tea extract, while the orange bar represents the water-treated control. A T-test revealed a statistically significant difference between the treatments at 2 days post-inoculation (n=3, p<0.01).

### DETAILED DESCRIPTION

Many modifications and other embodiments disclosed herein will come to mind to one skilled in the art to which the disclosed compositions and methods pertain to having the benefit of the teachings presented in the foregoing descriptions and the associated drawings. Therefore, it is to be understood that the disclosures are not limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred, in any respect. This holds for any possible non-express basis for interpretation, including matters of logic with respect to the arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a rare earth element” includes, but is not limited to, mixtures or combinations of two or more such elements.

It should be noted that ratios, concentrations, amounts, and other numerical data can be expressed herein in a range format. It will be further understood that the endpoints of each of the ranges are significant both in relation to the other endpoint and independently of the other endpoint. It is also understood that there are a number of values disclosed herein and that each value is also herein disclosed as “about” that particular value in addition to the value itself. For example, if the value “10” is disclosed, then “about 10” is also disclosed. Ranges can be expressed herein as from “about” one particular value and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less' and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur and that the description includes instances where said event or circumstance occurs and instances where it does not.

Unless otherwise specified, temperatures referred to herein are based on atmospheric pressure (i.e. one atmosphere).

The term “substantially” as used herein refers to the relative purity of a substance, where the purity of the substance is at least 90% pure, at least 95% pure, at least 99% pure, or at least 99.9% pure. A pure substance is composed of 100% of the substance.

The term “bacterial infection” as used herein is when a plant seed has been exposed to one or more bacteria and showing or possessing one or more symptoms of infection. In one aspect, the bacterial infection is bacterial fruit blotch (BFB). Bacterial fruit blotch affects the foliage at all growth stages and fruit of a wide range of hosts. Symptoms can be initially observed on seedlings, shortly after planting depending on the environmental conditions. For example, initial seedling symptoms include water-soaking on the undersides of cotyledons. Lesions having a greasy appearance are another symptom. Water-soaked lesions start as discrete spots but then coalesce and extend along the veins of cotyledons. Lesions can extend along stems to tissues of true leaves and in severe cases they can cause seedlings to collapse and die. Water-soaked lesions eventually dry to form elongated, dark to reddish-brown lesions that develop on and along cotyledon veins.

In one aspect, the bacteria is a seedborne plant or human pathogen selected from the group consisting of Xanthomonas axonopodis pv. phaseoli (cause of common bacterial blight) and Pseudomonas syringae pv. phaseolicola (cause of halo blight), Xanthomonas campestris pv. campestris-cauliflower, and Xanthomonas euvesicatoria-pepper, Xanthomonas euvesicatoria, and Pseudomonas syringae pv. glycinea, Clavibacter michiganensis subsp. michiganensis, or Serratia marcescens. In another aspect, the bacteria is Acidovorax citrulli.

The term “prevent” or “preventing” as used herein is defined as eliminating the likelihood of the occurrence of a bacterial infection (e.g., one or more symptoms associated with a bacterial infection) on a plant seed when compared to the same plant seed where the composition described herein has not been applied to the plant seed. The term “prevent” also includes the reduction in the severity of one or more symptoms associated with the bacterial infection when compared to the same plant seed where the composition described herein has not been applied to the plant seed. The reduction in severity of the one or more symptoms is equivalent to treating the plant seed that has been infected by one or more bacteria.

The term “reduce” or “reducing” as used herein is defined as reducing the likelihood of the occurrence of a bacterial infection (e.g., one or more symptoms associated with a bacterial infection) on a plant seed when compared to the same plant seed where the composition described herein has not been applied to the plant seed. The term “reduce” also includes the reduction in the severity of one or more symptoms associated with the bacterial infection when compared to the same plant seed where the composition described herein has not been applied to the plant seed. The reduction in severity of the one or more symptoms is equivalent to treating the plant seed that has been infected by one or more bacteria.

The term “plant seed” as used herein is any seed that when planted over time matures into a plant. The plant seed can be for agricultural plants (e.g., fruits and vegetables) and plants for landscaping (e.g., trees, shrubs, etc.).

The term tea (Camellia sinensis) as used herein is an evergreen bush. Tea leaves can be processed differently to produce white, green, oolong, or black teas.

### Methods for Preventing Bacterial Infection of Plant Seeds

Described herein are methods for preventing a bacterial infection on a plant seed. In one aspect, the method involves applying to the plant seed epigallocatechin-3 gallate, catechin, epicatechin, or any combination thereof. As demonstrated herein, one or more these compounds when applied to plant seeds is effective in prevention bacterial infection of the seeds.

In one aspect, a mixture comprising epigallocatechin-3 gallate, catechin, and epicatechin is applied to the plant seed. In one aspect, the mixture of components can be formulated as a dry powder that can be subsequently applied to the plant seeds. In another aspect, the mixture of components can be formulated in a suitable solvent such as, for example, water, that can be subsequently applied to the plant seeds.

When a mixture of epigallocatechin-3 gallate, catechin, and epicatechin is used, the relative amounts of each component can be varied. In one aspect, the weight ratio of catechin to epigallocatechin-3 gallate is from about 2:1 to about 6:1, or about 2:1, 2.5:1, 3:1, 3.5:1, 4:1, 4.5:1, 5:1, 5.5:1, or 6:1, where any value can be a lower and upper endpoint of a range (e.g., 3.5:1 to 4.5:1). In another aspect, the weight ratio of catechin to epicatechin is from about 0.5:1 to about 10:1, or about 0.5:1, 1:1, 1.5:1, 2:1, 2.5:1, 3:1, 3.5:1, 4:1, 4.5:1, 5:1, 6:1, 7:1, 8:1, 9:1, or 10:1, where any value can be a lower and upper endpoint of a range (e.g., 2:1 to 3:1). In another aspect, the weight ratio of catechin to epigallocatechin-3 gallate is from about 0.5:1 to about 5:1, or about 0.5:1, 1:1, 1.5:1, 2:1, 2.5:1, 3:1, 3.5:1, 4:1, 4.5:1, or 5:1, where any value can be a lower and upper endpoint of a range (e.g., 1:1 to 2:1).

In one aspect, the plant seeds are contacted with a tea. In one aspect, the tea is green tea. As demonstrated herein, green tea when applied to plant seeds is effective in prevention bacterial infection of the seeds. Green tea includes the components epigallocatechin-3 gallate, catechin, and epicatechin. In one aspect, the green tea can be prepared by boiling green tea leaves in water followed by straining to isolate the green tea solution. The concentration of the green tea can be modified as needed. In one aspect, the concentration green tea can be adjusted by spectrophotometry. In one aspect, the green tea has an optical density (OD₃₉₀) of from about 0.1 to about 10, or about 0.1, 0.5, 1, 2, 3, 4, 5, 6, 7, 8, 9, or 10, where any value can be a lower and upper endpoint of a range (e.g., 0.5 to 4). Non-limiting procedures for producing the teas and modifying the concentration are provided in the Examples.

Epigallocatechin-3 gallate, catechin, epicatechin, or any combination as well as the tea (e.g., green tea) can be applied to the plant seeds using techniques known in the art. In one aspect, epigallocatechin-3 gallate, catechin, epicatechin, or any combination as well as the tea can be applied to plant seeds by spraying a solution on the seeds or submersing/soaking the seeds in solutions composed of the components. In another aspect, epigallocatechin-3 gallate, catechin, epicatechin, or any combination as well as the tea (e.g., green tea) can be applied to the plant seeds by vacuum filtration. Non-limiting procedures for applying the compositions described herein to plant seeds are provided in the Examples.

In other aspects, the compositions described herein (epigallocatechin-3 gallate, catechin, epicatechin, or any combination or tea) can be applied to plant seeds in combination with one or more antibiotics. As demonstrated herein, the use of the compositions described herein in combination with an antibiotic produces a synergistic effect with respect to enhanced prevention of bacterial infection. In one aspect, the bacterial infection is reduced by a greater amount (e.g., greater than 50%, greater than 60%, or greater than 70%) when compared to the same plant seed where epigallocatechin-3 gallate, catechin, epicatechin, or any combination thereof is applied to the plant seed in the absence of the antibiotic.

In one aspect, the antibiotic is rifampicin, streptomycin, or a combination thereof. As demonstrated herein, when seeds were just treated with rifampicin, the prevention of bacterial infection was not observed. However, when rifampicin was used in combination with the compositions described herein, inhibition of bacterial infection was greater than when only the composition was applied.

In one aspect, the plant seed is sequentially contacted with the compositions described herein (epigallocatechin-3 gallate, catechin, epicatechin, or any combination or tea) and the antibiotic. In another aspect, the plant seed is concurrently contacted with the compositions described herein (epigallocatechin-3 gallate, catechin, epicatechin, or any combination or tea) and the antibiotic. In one aspect, the plant seed is contacted with a composition comprising water, epigallocatechin-3 gallate, catechin, epicatechin, or any combination thereof, and the antibiotic. In another aspect, the plant seed is contacted with a composition comprising tea (e.g, green tea) and the antibiotic. The concentration of the antibiotic can vary. In one aspect, the antibiotic has a concentration of about 10 μg/mL to about 1,000 μg/mL, or about 10 μg/mL, 50 μg/mL, 100 μg/mL, 200 μg/mL, 300 μg/mL, 400 μg/mL, 500 μg/mL, 600 μg/mL, 700 μg/mL, 800 μg/mL, 900 μg/mL, or 1,000 μg/mL, where any value can be a lower and upper endpoint of a range (e.g., 50 μg/mL to 200 μg/mL).

In another aspect, soil comprising epigallocatechin-3 gallate, catechin, epicatechin, or any combination thereof can be used to prevent or reduce a bacterial infection on a plant seed. In one aspect, epigallocatechin-3 gallate, catechin, epicatechin, or any combination thereof can be added to the soil. In this aspect, the epigallocatechin-3 gallate, catechin, epicatechin, or any combination thereof is not naturally present in the soil but added to the soil at a desired concentration. In one aspect, the epigallocatechin-3 gallate, catechin, epicatechin, or any combination thereof is added to the soil before and/or after the seed is planted in the soil. In one aspect, the soil is supplemented with green tea such as a solution in water or as a dry powder. Any type of sol can be supplemented with epigallocatechin-3 gallate, catechin, epicatechin, or any combination thereof. In one aspect, the soil is potting soil or topsoil. In other aspects, the soil is supplemented with an antibiotic as described above.

Plant seeds produced by the methods described herein ultimately will mature into plants with improved physical properties. The seedlings will germinate faster as well as produce greener and more robust plants that are less susceptible to disease as well possess fewer nutrient deficiency symptoms.

### ASPECTS

Aspect 1. A method for preventing or reducing a bacterial infection on a plant seed, the method comprising applying to the plant seed epigallocatechin-3 gallate, catechin, epicatechin, or any combination thereof.

Aspect 2. The method of Aspect 1, wherein a mixture comprising epigallocatechin-3 gallate, catechin, and epicatechin is applied to the plant seed.

Aspect 3. The method of Aspect 1 or 2, wherein the epigallocatechin-3 gallate, catechin, and epicatechin are pure or substantially pure.

Aspect 4. The method of any one of Aspects 1-3, wherein epigallocatechin-3 gallate, catechin, epicatechin, or any combination thereof is applied to the plant seed as a dry powder or as solution in water.

Aspect 5. The method of any one of Aspects 1-4, wherein catechin and epigallocatechin-3 gallate are applied to the plant seed, wherein the weight ratio of catechin to epigallocatechin-3 gallate is from about 2:1 to about 6:1.

Aspect 6. The method of any one of Aspects 1-4, wherein catechin and epicatechin are applied to the plant seed, wherein the weight ratio of catechin to epicatechin is from about 0.5:1 to about 10:1.

Aspect 7. The method of any one of Aspects 1-4, wherein epicatechin and epigallocatechin-3 gallate are applied to the plant seed, wherein the weight ratio of catechin to epigallocatechin-3 gallate is from about 0.5:1 to about 5:1.

Aspect 8. The method of any one of Aspects 1-11, wherein the plant seed is contacted with epigallocatechin-3 gallate, catechin, epicatechin, or any combination thereof by vacuum infiltration.

Aspect 9. The method of any one of Aspects 1-8, wherein the plant seed is contacted with a tea.

Aspect 10. The method of any one of Aspects 1-8, wherein the plant seed is contacted with green tea.

Aspect 11. The method of Aspect 9 or 10, wherein the green tea is produced by boiling the leaves of green tea in water prior to contact the plant seed with the green tea.

Aspect 12. The method of Aspects 9 or 10, wherein the green tea has an optical density (OD₃₉₀) of from about 0.1 to about 10.

Aspect 13. The method of any one of Aspects 9-12, wherein the plant seed is contacted with the tea by vacuum infiltration.

Aspect 14. The method of any one of Aspects 1-13, wherein the plant seed is further contacted with an antibiotic.

Aspect 15. The method of Aspect 14, wherein the plant seed is sequentially contacted with epigallocatechin-3 gallate, catechin, epicatechin, or any combination thereof and the antibiotic.

Aspect 16. The method of Aspect 14, wherein the plant seed is concurrently contacted with epigallocatechin-3 gallate, catechin, epicatechin, or any combination thereof and the antibiotic.

Aspect 17. The method of Aspect 14, wherein the plant seed is contacted with a composition comprising water, epigallocatechin-3 gallate, catechin, epicatechin, or any combination thereof, and the antibiotic.

Aspect 18. The method of Aspect 14, wherein the plant seed is sequentially contacted with green tea and the antibiotic.

Aspect 19. The method of Aspect 14, wherein the plant seed is concurrently contacted with green tea and the antibiotic.

Aspect 20. The method of Aspect 14, wherein the plant seed is contacted with a composition comprising green tea and the antibiotic.

Aspect 21. The method of any one of Aspects 14-20, wherein the antibiotic is rifampicin, streptomycin, or a combination thereof.

Aspect 22. The method of any one of Aspects 14-21, wherein the antibiotic has a concentration of about 10 μg/mL to about 1,000 μg/mL.

Aspect 23. The method of any one of Aspects 14-22, wherein bacterial infection is reduced by a greater amount when compared to the same plant seed where epigallocatechin-3 gallate, catechin, epicatechin, or any combination thereof is applied to the plant seed in the absence of the antibiotic.

Aspect 24. The method of any one of Aspects 1-23, wherein the bacteria is a seedborne plant or human pathogen selected from the group consisting of Xanthomonas axonopodis pv. phaseoli (cause of common bacterial blight) and Pseudomonas syringae pv. phaseolicola (cause of halo blight), Xanthomonas campestris pv. campestris-cauliflower, and Xanthomonas euvesicatoria-pepper, Xanthomonas euvesicatoria, and Pseudomonas syringae pv. glycinea, Clavibacter michiganensis subsp. michiganensis, or Serratia marcescens.

Aspect 25. The method of any one of Aspects 1-23, wherein the bacteria is Acidovorax citrulli.

Aspect 26. The method of any one of Aspects 1-25, wherein bacterial infection is reduced by at least 50% when compared to the same plant seed where epigallocatechin-3 gallate, catechin, epicatechin, or any combination thereof is not applied to the plant seed.

Aspect 27. The method of any one of Aspects 1-26, wherein the plant seed comprises a fruit seed or a vegetable seed.

Aspect 28. The method of any one of Aspects 1-26, wherein the plant seed comprises a seed for producing a plant for use in landscaping.

Aspect 29. A plant seed produced by the method of any one of Aspects 1-28.

Aspect 30. A plant produced by a seed of Aspect 29.

Aspect 31. The plant of Aspect 30, wherein the plant is greener and possesses fewer nutrient deficiency symptoms when compared to a plant grown the from the seed not produced by the method of any one of Aspects 1-28.

Aspect 32. A method for preventing or reducing a bacterial infection on a plant seed, the method comprising planting the seed in soil comprising epigallocatechin-3 gallate, catechin, epicatechin, or any combination thereof, wherein epigallocatechin-3 gallate, catechin, epicatechin, or any combination thereof is added to the soil before or after the seed is planted in the soil.

Aspect 33. Soil comprising epigallocatechin-3 gallate, catechin, epicatechin, or any combination thereof, wherein epigallocatechin-3 gallate, catechin, epicatechin, or any combination thereof is added to the soil.

Aspect 34. The method or soil of Aspect 32 or 33, wherein a mixture comprising epigallocatechin-3 gallate, catechin, and epicatechin is applied to the plant seed.

Aspect 35. The method or soil of any one of Aspects 32-34, wherein the epigallocatechin-3 gallate, catechin, and epicatechin are pure or substantially pure.

Aspect 36. The method or soil of any one of Aspects 32-35, wherein epigallocatechin-3 gallate, catechin, epicatechin, or any combination thereof is applied to the soil as a dry powder or as solution in water.

Aspect 37. The method or soil of any one of Aspects 32-36, wherein the weight ratio of catechin to epigallocatechin-3 gallate is from about 2:1 to about 6:1.

Aspect 38. The method or soil of any one of Aspects 32-36, wherein the weight ratio of catechin to epicatechin is from about 0.5:1 to about 10:1.

Aspect 39. The method or soil of any one of Aspects 32-36, wherein epicatechin and epigallocatechin-3 gallate are applied to the plant seed, wherein the weight ratio of catechin to epigallocatechin-3 gallate is from about 0.5:1 to about 5:1.

Aspect 40. The method or soil of any one of Aspects 32-39, wherein the plant seed is contacted with epigallocatechin-3 gallate, catechin, epicatechin, or any combination thereof by vacuum infiltration.

Aspect 41. The method or soil of any one of Aspects 32-40, wherein the soil is contacted with a tea.

Aspect 42. The method or soil of any one of Aspects 32-40, wherein the soil is contacted with green tea.

Aspect 43. The method or soil of Aspect 41 or 42, wherein the green tea is produced by boiling the leaves of green tea in water prior to contact the plant seed with the green tea.

Aspect 44. The method or soil of Aspects 41 or 42, wherein the green tea has an optical density (OD₃₉₀) of from about 0.1 to about 10.

Aspect 45. The method or soil of any one of Aspects 32-44, wherein the soil is further contacted with an antibiotic.

Aspect 46. The method or soil of Aspect 45, wherein the soil is sequentially contacted with epigallocatechin-3 gallate, catechin, epicatechin, or any combination thereof and the antibiotic.

Aspect 47. The method or soil of Aspect 45, wherein the soil is concurrently contacted with epigallocatechin-3 gallate, catechin, epicatechin, or any combination thereof and the antibiotic.

Aspect 48. The method or soil of Aspect 45, wherein the soil is contacted with a composition comprising water, epigallocatechin-3 gallate, catechin, epicatechin, or any combination thereof, and the antibiotic.

Aspect 49. The method or soil of Aspect 45, wherein the soil is sequentially contacted with green tea and the antibiotic.

Aspect 50. The method or soil of Aspect 45, wherein the soil is concurrently contacted with green tea and the antibiotic.

Aspect 51. The method or soil of Aspect 45, wherein the soil is contacted with a composition comprising green tea and the antibiotic.

Aspect 52. The method or soil of any one of Aspects 45-51, wherein the antibiotic is rifampicin, streptomycin, or a combination thereof.

Aspect 53. The method or soil of any one of Aspects 45-51, wherein the antibiotic has a concentration of about 10 μg/mL to about 1,000 μg/mL.

Aspect 54. The method or soil of any one of Aspects 45-53, wherein bacterial infection is reduced by a greater amount when compared to the same plant seed where epigallocatechin-3 gallate, catechin, epicatechin, or any combination thereof is applied to the plant seed in the absence of the antibiotic.

Aspect 55. The method or soil of any one of Aspects 32-54, wherein the bacteria is a seedborne plant or human pathogen selected from the group consisting of Xanthomonas axonopodis pv. phaseoli (cause of common bacterial blight) and Pseudomonas syringae pv. phaseolicola (cause of halo blight), Xanthomonas campestris pv. campestris-cauliflower, and Xanthomonas euvesicatoria-pepper, Xanthomonas euvesicatoria, and Pseudomonas syringae pv. glycinea, Clavibacter michiganensis subsp. michiganensis, or Serratia marcescens.

Aspect 56. The method or soil of any one of Aspects 32-54, wherein the bacteria is Acidovorax citrulli.

Aspect 57. The method or soil of any one of Aspects 32-56, wherein bacterial infection is reduced by at least 50% when compared to the same plant seed where epigallocatechin-3 gallate, catechin, epicatechin, or any combination thereof is not applied to the plant seed.

Aspect 58. The method or soil of any one of Aspects 32-57, wherein the plant seed comprises a fruit seed or a vegetable seed.

Aspect 59. The method or soil of any one of Aspects 32-57, wherein the plant seed comprises a seed for producing a plant for use in landscaping.

Aspect 60. The method or soil of any one of Aspects 32-59, wherein the soil is potting soil or topsoil.

### EXAMPLES

The following examples are put forth so as to provide those of ordinary skill in the art with a complete disclosure and description of how the compounds, compositions, and methods described and claimed herein are made and evaluated and are intended to be purely exemplary and are not intended to limit the scope of what the inventors regard as their invention. Efforts have been made to ensure accuracy with respect to numbers (e.g., amounts, temperature, etc.) but some errors and deviations should be accounted for.

Unless indicated otherwise, parts are parts by weight, the temperature is in ° C. or is at ambient temperature, and pressure is at or near atmospheric. Numerous variations and combinations of reaction conditions (e.g., component concentrations, desired solvents, solvent mixtures, temperatures, pressures, and other reaction ranges and conditions) can be used to further optimize the reagent consumption while at the same time increase the extraction efficiency.

### Materials and Methods

A total of 7 American, Turkish, Chinese, and Japanese commercial brands of tea, including: H_gt (green tea), Y_gt (green tea, P_ogt (organic green tea), W_gt (green tea), P_gt (green tea), C_bt (black tea) and P_obt (organic black tea) were tested. Additionally, green tea dry extract herbal reference standard (HRS) with European Pharmacopoeia (EP) reference standard, catechin hydrate, epicatechin (EC), epigallocatechin (EGC), epicatechin gallate (ECG), and epigallocatechin gallate (EGCG) extracts were also used (Sigma Aldrich). The wild type AAC00-1 and M6 strains of A. citrulli, along with the aacI and aacR quorum-sensing mutants with rifampicin resistance and GFP signaling mutants of AAC00-1 and M6 strains with kanamycin resistance, were provided by the Walcott Laboratory of the University of Georgia.

Tea Preparation and Analysis of A. citrulli Growth in Culture

A. citrulli growth on LB agar medium was assessed after treatment with commercial brands of black and green teas and their constituent compounds to determine inhibitory effects. Dried loose tea leaves were boiled in distilled water, strained, and liquid added to LB agar growth medium to assess concentration effects. Five grams of loose-leaf tea was autoclaved in 200 mL distilled water for 25 minutes in the liquid cycle. After autoclaving, the tea was cooled to room temperature and filtered using Whatman #1 filter paper. The filtered tea was adjusted by spectrophotometry (DU 800, Beckman Coulter) to 4.0, 3.0, 2.0, 1.0, and 0.5 at OD₃₉₀.

### Bacterial Strain Preparation

Acidovorax citrulli group-I strain AAC00-1, and group-II strain representative M6, aacI, and aacR quorum-sensing mutants of AAC00-1 were streaked on LB agar growth medium with selective antibiotic rifampicin (Fisher BioReagents) 100 μg/mL and incubated at 28° C. for 48 hours. Luria Broth (LB) agar growth medium was prepared by mixing 10 grams of tryptone, 5 grams of yeast extract, and 10 grams of sodium chloride, and 15 grams of Bacto™ Agar Solidifying Agent (BD Diagnostics) in 1 liter of distilled water (pH: 7.5) before autoclaving. Collected bacteria were resuspended in autoclave-sterilized 10 mM MgCl₂, and adjusted to 1.0, 0.5, 0.1, 0.01, and 0.001 OD₆₀₀ spectrophotometry.

The dilutions were made accordingly for the following compounds: Green tea dry extract herbal reference standards (HRS) with European Pharmacopoeia (EP) reference standards (0.5-1-2 mg:10 mL), of 1, 10 or 100 mM each for catechin hydrate, epicatechin (EC), epigallocatechin (EGC), epicatechin gallate (ECG), and epigallocatechin gallate (EGCG). 1 mL of each standard compound was added to 10 mL of LB agar growth medium.

Growth curve on growth medium containing inhibitory extracts and compounds to test whether Acidovorax citrulli could grow in the presence of green and black teas and some of their constituents, growth analysis was conducted in Petri dishes on solid LB agar containing tea or its extracts to quantitate bacterial growth inhibition. We also wanted to see whether tea and its constituents affected antibiotic resistance by comparing growth on both LB agar and Rifampicin containing LB agar. Tea and component treatments were added directly to liquid LB growth medium (1:10) with and without the selective antibiotic Rifampicin 100 μg/mL as separate replicates. Experiments were performed in 2 stages; in the first stage, bacterial growth was checked by blotting 5 μL of inoculum with 4 1:10 serial dilutions to confirm treatment effects. For the second stage, effects were verified by blotting 20 μL of inoculum with 9 1:10 serial dilutions to be able to count bacterial colonies. After growth medium solidified, 5 μL of bacterial inoculum adjusted at OD₆₀₀: to 1.0, 0.5, 0.1, 0.01, or 0.001 (at first stage) and 20 μL of bacterial inoculum adjusted to OD₆₀₀: 10⁰, 10⁻¹, 10⁻², 10⁻³, 10⁻⁴, 10⁻⁵, 10⁻⁶, 10⁻⁷, 10⁻⁸, 10⁻⁹ were blotted on the LB agar growth medium, containing tea samples or other extracts (1:10 mL). The Petri dishes inoculated with bacteria were incubated at 28° C. for 72 h in dark. Autoclaved distilled water was added to growth medium in a separate replicate with 5 μL of 10 mM MgCl₂ and bacteria as a negative control. In order to check if additional distilled water affected bacterial growth, growth on LB medium with and without water was compared. Results were compared by colonies. When colonies could not be separated, bacterial growth was scored between 1 and 0 depending on the amount of growth on the surface of the blot.

### High-Performance Liquid Chromatography (HPLC) Analysis

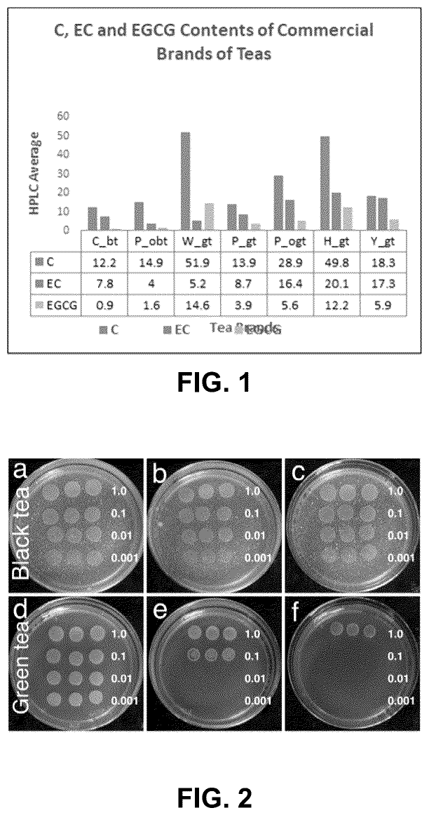

To quantitate tea flavonoids, catechin (C), epicatechin (EC), and epigallocatechin gallate (EGCG) tea solutions were subjected to high-performance liquid chromatography (HPLC, Shimadzu, LC20; Phenomenex, Kinetex C18 column (2.6 μm, 100 Å, 100×4.60 mm)) in the Sobrado Laboratory in the Department of Biochemistry Virginia Tech. A modified Fast gradient HPLC/MS separation protocol of phenolics in green tea was used (S̆ilarová, et al., 2017). Reference compounds, catechin, epicatechin, epigallocatechin gallate, were diluted with DI water and to generate standard curves (Table. 1, 2; FIG. 1). Preferred concentrations were 30 mg/mL, EC 10 mg/mL, and EGCG 20 mg/mL. Tea solutions were centrifuged at 16800×g for 15 min to remove precipitates. The supernatant was diluted 1:10 with deionized water and injected for HPLC analysis. The HPLC gradient method consisted of Buffer, A, water with 0.1% formic acid (99.0+%, Optima LC/MS Grade, Fisher Scientific), and Buffer B, acetonitrile (HPLC grade, Fisher Scientific). Buffer A and B total was a 100%.

TABLE 1
HPLC gradient used for tea flavonoid separation

| Time (min) | Buffer B Concentration (%) |
|---|---|
| 2 | 5 |
| 20 | 59 |
| 24 | 80 |
| 28 | 80 |
| 33 | 5 |
| 40 | Stop |

TABLE 2
HPLC retention time for compounds

| Compound | Retention time (min) |
|---|---|
| Catechin (C) | 14.95 |
| Epicatechin (EC) | 16.27 |
| Epigallocatechin gallate (EGCG) | 16.70 |

### Field Emission Scanning Electron Microscope (FESEM) Imaging

To have a better understanding of the effects of green tea on bacterial structure, treated and wild type M6 and AAC00-1 strains of Acidovorax citrulli were viewed by LEO-FESEM high-resolution scanning electron microscopy (SEM) at the Institute for Critical Technology and Applied Science (ICTAS) at Virginia Tech. The LEO (Zeiss) 1550 is a high-performance Schottky field-emission SEM. Bacterial samples grown on LB agar plates incubated at 28° C. on a shaker before visualization after 12 hour exposure to Yamamotoyama green tea (OD₃₉₀:4.5). After treatment, the mixture was centrifuged at 12,000 rpm for 1 minute, and 200 μL of the supernatant was pipetted into a microfuge tube in a biological safety hood for 1 hour for drying. Samples were sputter coated with 7 nm gold platinum-coated with Leica EM TIC 3X for the LEO-FESEM imaging.

### Seed Treatment Experiments

Treatments to sanitize seeds infected with Acidovorax citrulli were conducted on melon (Cucumis melo L.) cantaloupe cv. Hales Best Jumbo and watermelon (Citrullus lanatus (Thunb.) Matsum. & Nakai) cv. Crimson Sweet (Eden Seed Company, Arden, NC). Both are open-pollinated, representative commercial cultivars with known susceptibility to BFB disease.

Seed Inoculation with Acidovorax citrulli Group-II Strain M6

Untreated ‘Hales Best Jumbo’ and ‘Crimson Sweet’ seeds were inoculated with Acidovorax citrulli group-II strain representative M6 expressing green fluorescent protein (GFP) both by vacuum infiltration and seed coat inoculation methods. Bacteria grown and selected with kanamycin 50 μg/mL (Fisher BioReagents) for 48 hours were resuspended in autoclaved 10 mM MgCl₂ and adjusted by spectrophotometry (model DU 800, Beckman Coulter) to bacterial optical density (600 nm) of 1.0, 0.1, 0.01, 0.001 measured at OD₆₀₀. Five hundred seeds of each cultivar were submerged in bacterial inoculum in 250 mL Erlenmeyer or Buchner flask. For pericarp inoculation, Erlenmeyer flask was placed on a rotary shaker (New Brunswick Scientific Co. Inc. Edison N.J. U.S.A. (0-500 rpm)), at 350 rpm for 2 hours at room temperature. For vacuum infiltration, a capped Buchner flask containing seed submerged in bacterial inoculum was attached to a vacuum pump in a fume hood. The flask was evacuated until no new air bubbles could be visualized leaving seeds. After vacuum infiltration, seeds were blotted dried with paper and stored in a desiccator with freshly charged desiccator containing oven dry clay beads until the relative humidity reached a constant 40%.

### Green Tea Seed Treatment

Watermelon, ‘Crimson Sweet’ seeds were inoculated in solutions of 1.0 and 0.001 OD₆₀₀ M6_GFP tagged strain of bacteria. 200 seeds each of M6_GFP inoculated seeds were covered with green tea (Y_gt, OD₃₉₀:4.0) in sterile 50 mL flasks and gently agitated for 2 hours at 22° C. The seeds then were again vacuum infiltrated as explained in the seed inoculation step. After tea treatment seeds were blot-dried and stored in a desiccator until the relative humidity (RH) reached 40%.

### QPCR Comparison

To confirm the efficacy of tea treatments, the presence or absence of bacterial DNA in extracts of treated seeds was confirmed via quantitative PCR (qPCR). qPCR also allowed the minimum bacterial threshold of tea treatments to be determined. The primer boxes and probes previously designed by Ha 2009 were used (Table. 3). The microbial extraction, DNA extraction, and qPCR protocol reported by Giovanardi 2018 were used with some minor modifications.

Microbial Isolation from Seeds

Five infected seeds were soaked for 16 hours in 5 ml of NaPBS buffer (137 mM NaCl, 2.7 mM KCl, ten mM Na2HPO4, 1.8 mM KH₂PO₄; pH=7.2) with 0.2% Tween 20 at room temperature on a rotary shaker at 250 rpm. Some seeds were also ground in a sterilized mortar and pestle in filtered NaPBS buffer. As a positive control AAC00-1 bacteria solution with an optical density adjusted to 0.1 (˜107 cfu) in NaPBS buffer diluted 1:10 mL was added to some seed extracts to produce bacterial concentrations of approximately 10⁶ cfu) (Giovanardi 2018). After grinding, samples were centrifuged at 1,300×g for five minutes at 4° C. and the supernatant was transferred to a new tube centrifuged again at 10,000×g for 20 min. at 4° C. to eliminate seed debris. The pellet containing the bacteria was resuspended in 1 ml of sterilize deionized water.

DNA Extraction from Microbial Extracts

Bacterial DNA was extracted using a DNeasy UltraClean Microbial Kit (Qiagen) according to manufacture recommendations.

### QPCR

A 25 μL PCR reaction mix consisting of 12.5 μL Biorad IQ Supermix, 6.4 μL sterilized deionized water, 0.5 μL AAC00-1 probe (10 mM) (Fig.), 0.3 μL of forward and reverse primers (25 mM) (Fig.) and 5 μL of genomic DNA per reaction was mixed by the help of a pipette in a microfuge tube. QPCR program with quantitation relative standard curve with TaqMan reagents was performed with 95° C. (3′) denaturation followed by 95° C. (15″) and 60° C. (40″) (40 cycles) annealing and elongation. The target was FAM reporter for BOX AAC (FR), NFQ-MGB quencher.

TABLE 3
Sequences and functions of primers and a probe used for
qPCR detection of A. citrulli AAC00-1 (Ha 2009).

| Oligonucleotide | DNA sequence (5′→3′) | Function |
|---|---|---|
| BOXAACF | GCGTATGAGTCCCGA AGA AAT | A. citrulli |
| | | forward primer |
| BOXAACR2 | GCA TGCCTTGTATTCAGCTAT | A. citrulli |
| | | reverse primer |
| AAC PROBE | 6-FAM-CCGAAATCCGTA | A. citrulli |
| | TTGGACGGATCGAA-BHQ1* | TaqMan probe |

*The A. citrulli TaqMan probe was labeled at the 5′ and 3′ ends with 6-carboxyfluorescein (6-FAM) and Black Hole Quencher (BHQ) 1 (Integrated DNA Technologies, Coralville, IA), respectively.

### GFP Localization on Seed to Seedling Transmission Assays

The GFP localization of BFB in seed to seedling transmission assays was performed by Rachel Canalichio at George Washington University. The GFP-tagged M6 bacteria on seedling roots and/or cotyledons was visualized by epifluorescence stereomicroscopy (Olympus SZX12, FIG. 6, 7). Green tea-treated seeds were grown at 90% relative humidity for 4 days and assessed visually and under the fluorescence microscope for BFB lesioning and presence of GFP. The experiment was performed in two replicates to confirm findings.

### Statistical Analysis

All statistical analysis and the visualization of the data except for the HPLC were performed on R-Studio Version 1.3.1093 © 2009-2020 with ANOVA 2 and 3-factor analysis. Assumptions were checked and confirmed via the Tukey HSD test. The HPLC graphs were made in Microsoft Word Excel Version 16.45 (21011103)© 2021. For statistical significance to be evaluated, all experiments were performed in 3 replications and 2-3 Factor ANOVA was performed and confirmed with a Tukey Honest Significant Differences (HSD) analysis.

### Results

Experiments with Cultured A. citrulli and Tea Compounds

### Growth Curve on Growth Medium Containing Tea Extracts and Compounds

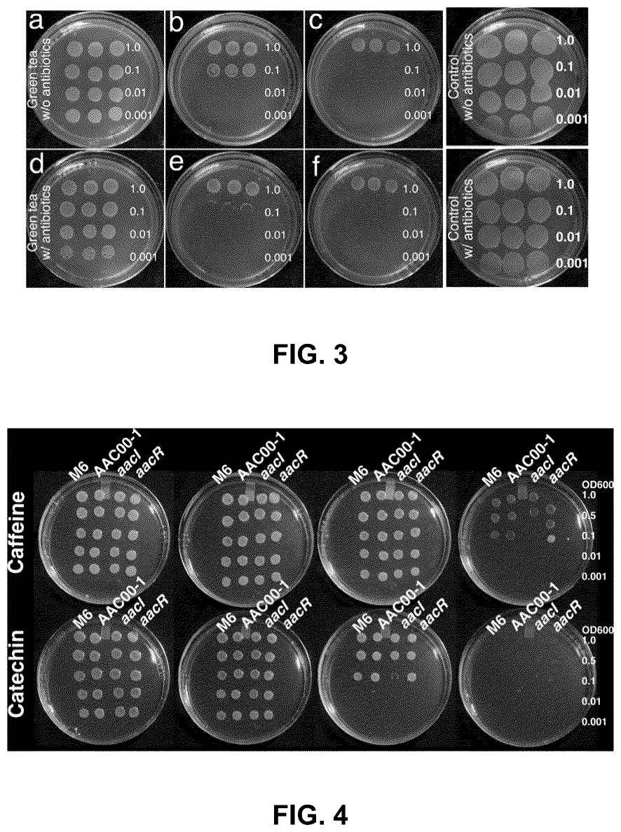

Green (H_gt) and black teas from Turkey were compared for their antimicrobial effects. Other work compared the antibacterial effectiveness of caffeine and catechin hydrate as well as green tea versus antibiotics (data not shown, FIG. 2). Inhibition of A. citrulli by green tea and catechin was greater than black tea and caffeine (not shown). Media containing 10% green tea completely inhibited growth of dilute BFB solutions. Increasing green tea to 20% completely inhibited bacterial growth except solutions of OD₆₀₀: 1.0 (FIG. 2). Black tea treated media did not inhibit A. citrulli strain AA000-1 growth (FIG. 2). In an experiment comparing effects of green tea to the antibiotic rifampicin, green tea alone showed similar inhibition of AA000-1 described in FIG. 2. Rifampicin used alone did not inhibit BFB growth. As a result of these preliminary experiments, additional experiments were performed with media containing 10% additive test compounds. However, when green tea (H_gt) was combined with the selective antibiotic rifampicin at 100 μg/mL inhibition of BFB was greater than green tea alone (FIG. 3). The synergistic effect of green tea and rifampicin was unexpected and raise questions about the possible mechanisms of inhibition between antibiotics and green tea.

Both green and black teas are products from leaves of Camellia sinensis that are processed differently. Caffeine is present in both green and black tea and is a QS inhibitor. Black tea has higher caffeine content than green. Catechins are converted into theaflavins during processing of black tea. Possible effects of caffeine and catechin on A. citrulli were examined in Petri plate experiments. Only the highest concentration of 10 mM caffeine inhibited both wild-type and QS mutant strains of A. citrulli at 0.01 and 0.001 OD₆₀₀ (FIG. 4). Both 1 and 10 mM catechin inhibited A. citrulli. Therefore, additional experiments focused on the inhibitory effects of catechin on A. citrulli.

In addition to visualization of inhibition by catechin and caffeine, 3-Way ANOVA analysis was performed with mean separation by Tukey HSD analysis on R-Studio (Supp. FIG. 1-2-3-4-5). Statistically significant treatments, treatment and bacterial concentrations (significance level 95%) were found. There were no differences found among bacterial strains (Supp. FIG. 1). Overall, there was ˜25% less A. citrulli growth in catechin treatments compared to caffeine treatment (95% significance level).

A comparison of green tea dry extract (Sigma Aldrich), H_gt loose leaf green tea, and epigallocatechin (EGC) was performed on increasing densities of A. citrulli strain AAC00-1. Only 1 mM EGC was an efficient inhibitor against OD₆₀₀: 0.1 and 0.01 bacteria. For the lower bacterial concentration of OD₆₀₀:0.001 only a minimum of 0.5 mM EGC was required for inhibition (FIG. 6.). For OD₆₀₀: 0.01 bacteria, both H_gt green tea, and dry green tea extract showed equal inhibition at both concentrations (FIG. 6.). Green tea and extract at OD₃₉₀:4.0 efficiently inhibited the highest concentration of bacteria (OD₆₀₀:1.0) (FIG. 6.). Three concentrations of green tea dry extract, 0.5-1-2 mg/10 mL were tested against OD₆₀₀: 1.0 bacteria, and a minimum of 1 mg/10 mL was completely inhibitory (FIG. 6).

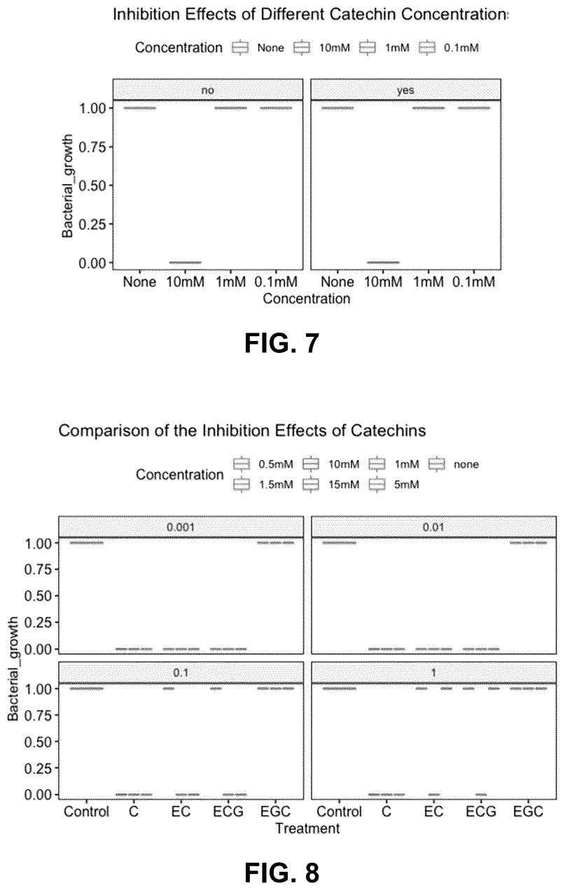

When different catechin concentrations were compared, only 10 mM was inhibitory (FIG. 7).

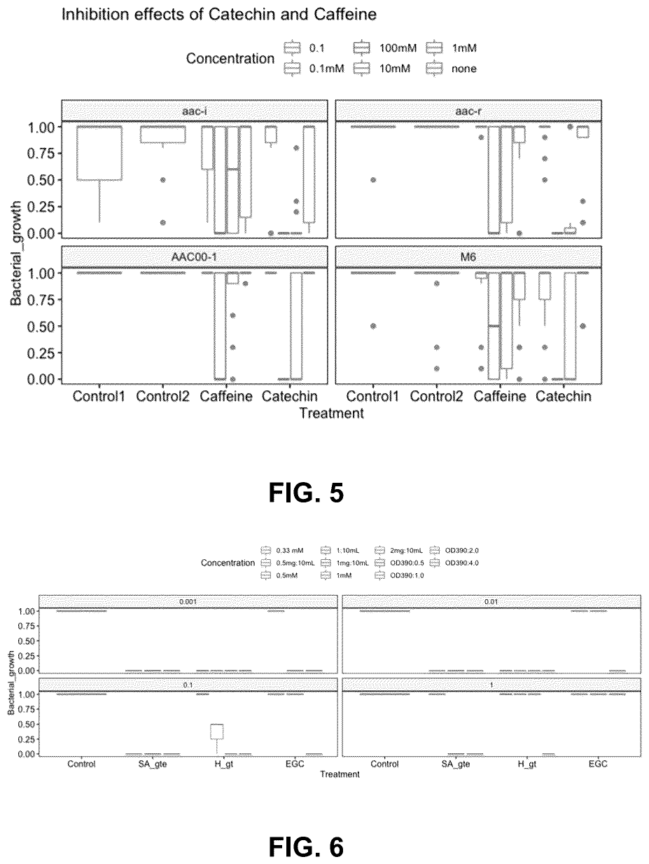

Inhibitory effects of catechin (C, 5-10-15 mM), epicatechin (EC, 0.5-1-1.5 mM), epicatechin gallate (ECG 0.5-1-1.5 mM), epigallocatechin (EGC 0.5-1-1.5 mM) against AA000-1 strain (OD₆₀₀:1.0, 0.1, 0.01, 0.001) were compared (FIG. 8). At bacterial OD₆₀₀: 1.0, treatment with 1.5 mM EC and ECG were completely inhibitory. FIGS. 4 and 5 did not show a high level of inhibition effect between 1-10 mM concentrations of catechin, but increasing concentrations 10-fold improved inhibition. On the other hand, EGC did not show inhibitory effects even at the lowest concentrations of bacteria. However, 0.5 mM of EC and ECG inhibited bacterial growth at the maximum bacterial concentration of OD₆₀₀:0.01. Our statistical analysis confirmed statistical significance between treatments and the concentrations at 95% confidence level.

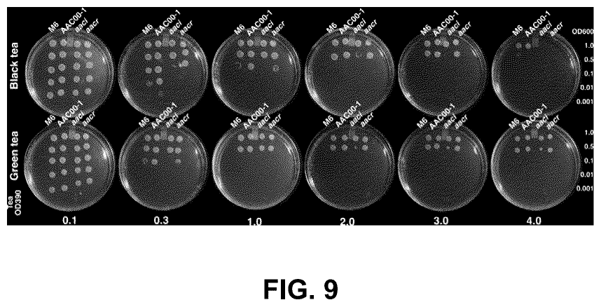

After preliminary assays were completed, further comparisons were made between different commercial brands of green (powder green tea) and black (organic black tea) than were tested previously (FIG. 9). Greater inhibition of cultured A. citrulli strains was observed suggesting different sources of tea behaved differently (FIG. 2).

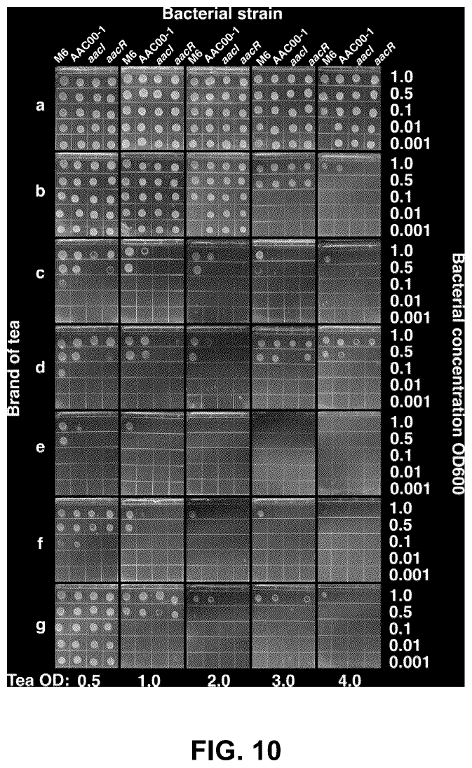

Therefore, a more rigorous comparison of commercial brands of green and black teas were conducted. C_bt (black tea), P_obt (organic black tea), P_ogt (organic green tea), P_gt (powder green tea), H_gt (green tea), W_gt (green tea), Y_gt (green tea) teas were compared on growth curve assay, with 10% tea containing LB agar growth medium (FIG. 10). In these assays, there were statistically significant differences (95% confidence level) among green tea, black tea, antibiotics, tea concentrations, and bacterial concentration. In this comparison, C_bt black tea was not different from the control. On the other hand, the P_obt was ˜33% more effective in preventing bacterial growth compared to C_bt and ˜34.5% more effective than the control. H_gt green tea reduced bacterial growth ˜86% compared to control and was found to be the most inhibitory tea. P_gt reduced bacterial growth ˜49%, P_ogt reduced the bacterial growth ˜68%, W_gt reduced growth ˜74%, and Y_gt has reduced bacterial growth a ˜61% all compared to the untreated control.

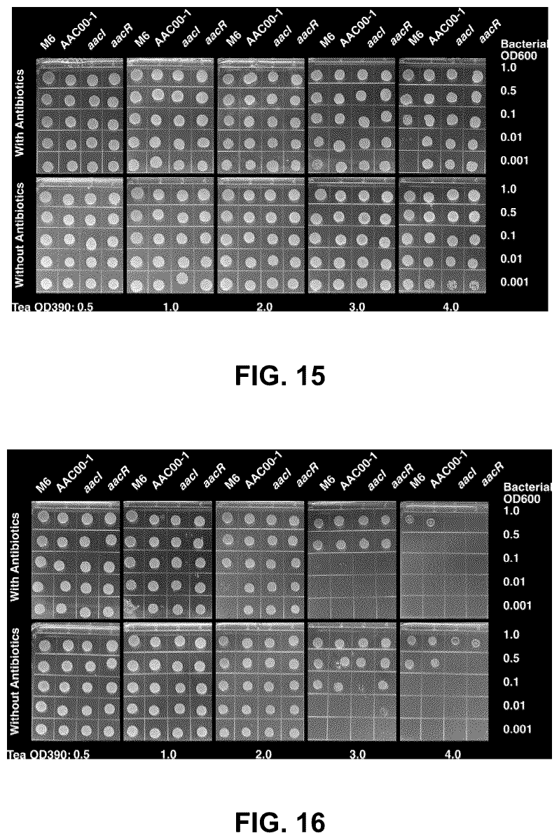

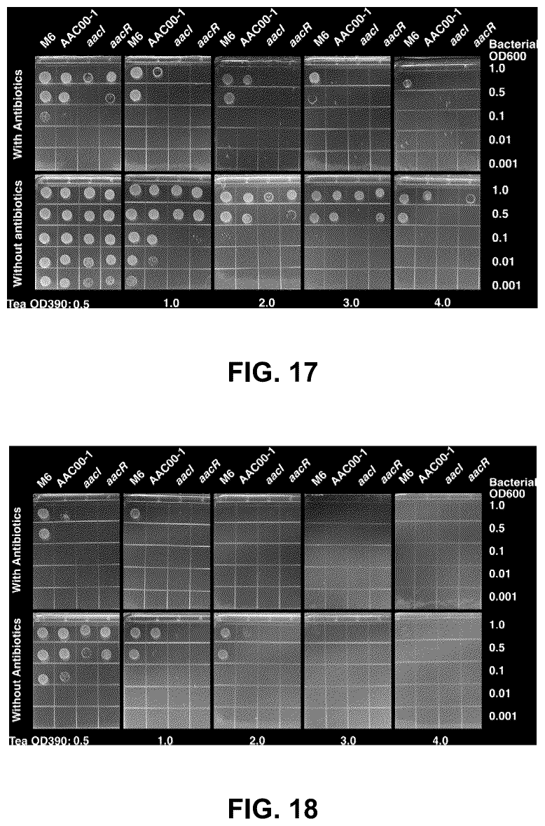

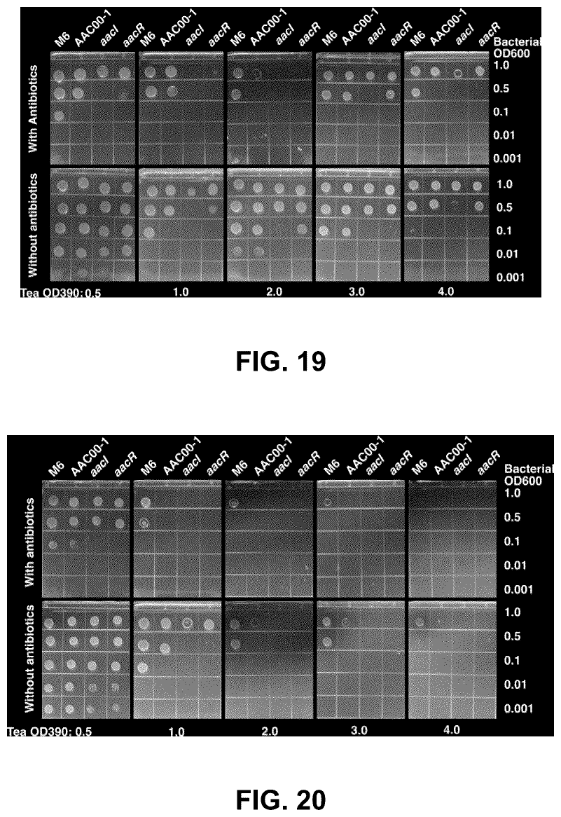

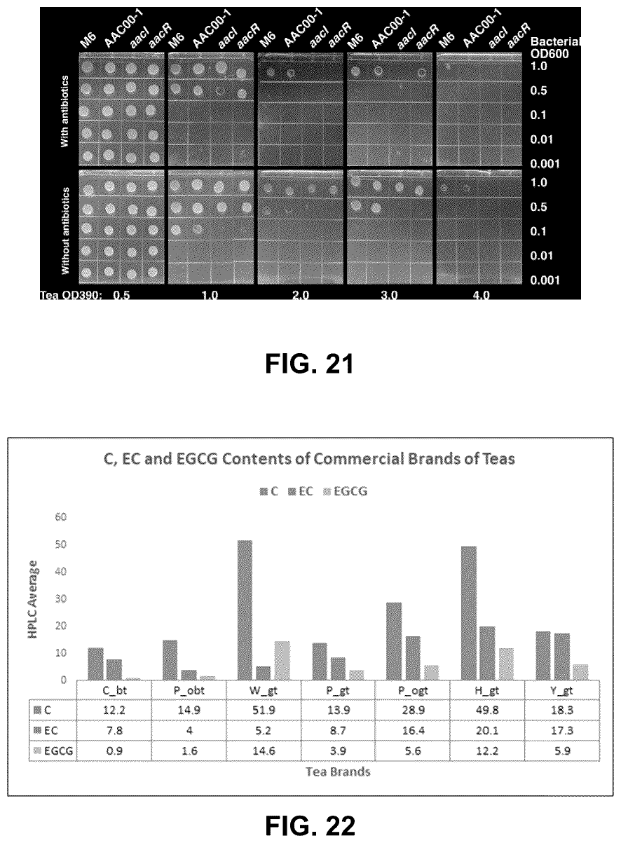

Overall, antibiotics reduced bacterial growth ˜13% (95% statistical confidence) (FIG. 15-21). Overall, bacterial concentrations from 0.01-0.001 produced the smallest differences in growth (˜3% more on 0.01), the difference between 1.0 and 0.001 was greatest (˜45% more growth on 1.0). While there was no statistically significant difference between aacR and aacI, mutant growth was reduced ˜7% and ˜6% by inhibitors (95% confidence level) compared to the wild type AA000-1, respectively.

At tea optical densities of 2, 3, or 4.0, H_gt completely inhibited bacterial growth even for the highest bacterial concentrations tested (FIG. 10). At 4.0 tea OD₃₉₀, H_gt and W_gt completely inhibited bacterial growth (FIG. 10). Overall, P_ogt, H_gt, W_gt, Y_gts showed the greatest inhibition among tea treatments (FIG. 10). At the lowest tea optical density, OD₃₉₀:0.5, P_ogt, P_gt, H_gt, W_gt brands each showed detectable inhibition (FIG. 10).

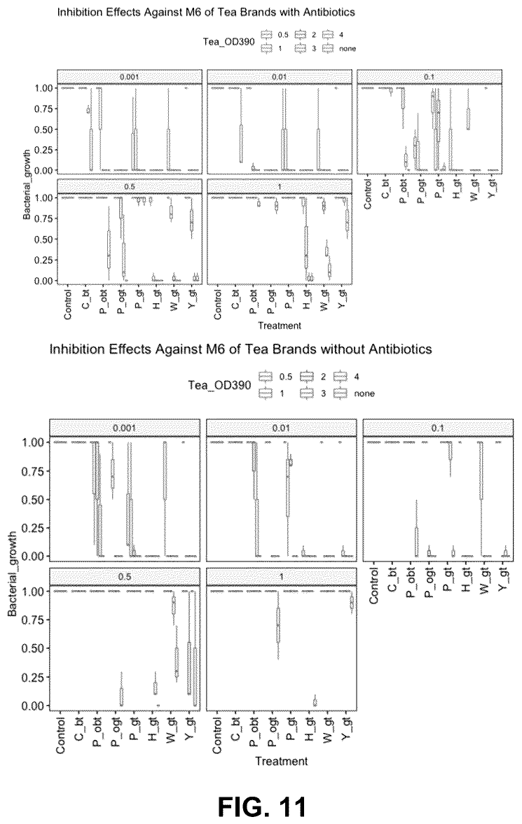

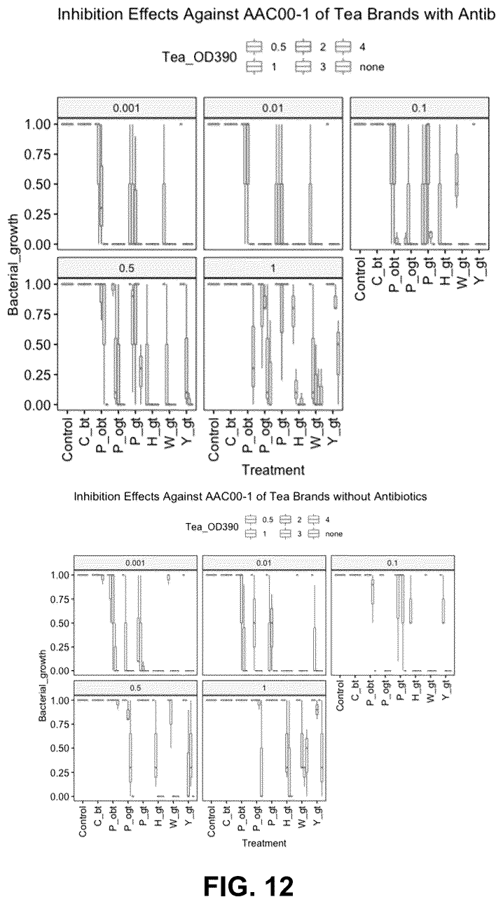

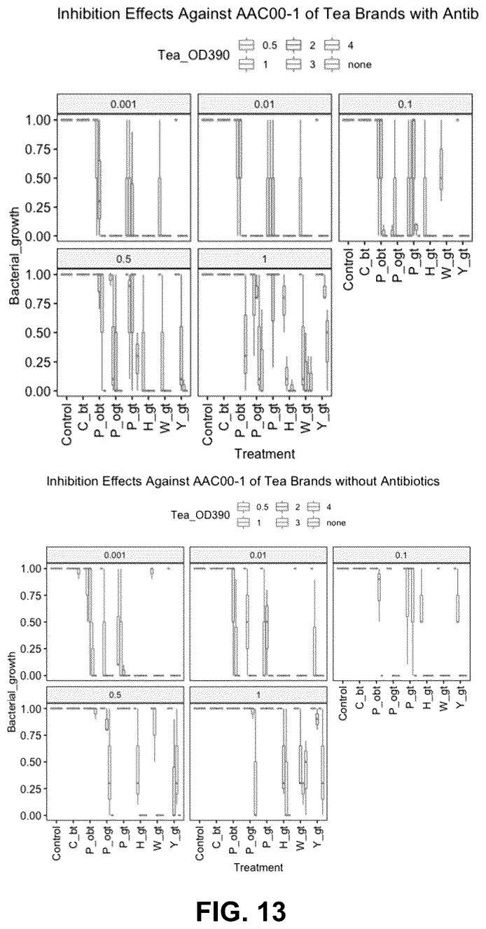

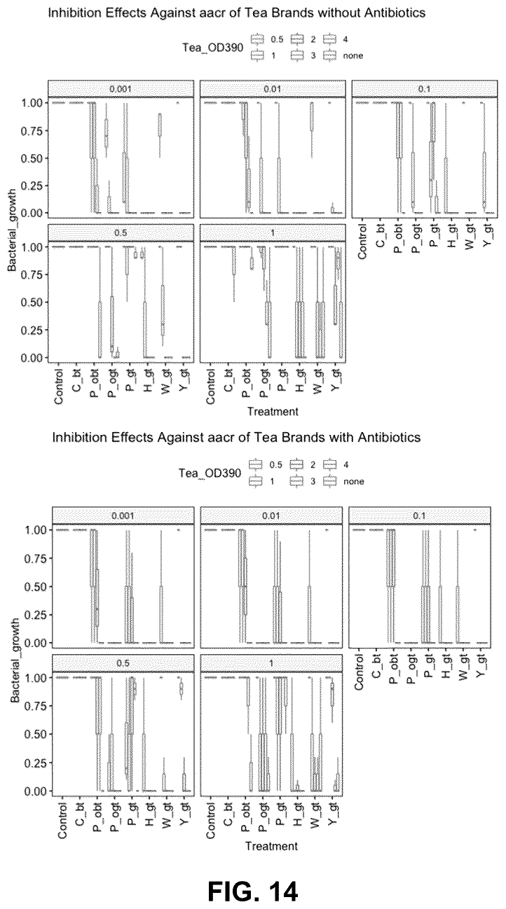

There was little difference in inhibition across bacterial strains. Growth curve analyses for each bacterial strain with or without selective antibiotic rifampicin 100 μg/mL compared the inhibition of the cotreatment tea and antibiotic (FIG. 11-14). C_bt black tea did not improve inhibition when treated with rifampicin. All other teas brand inhibited bacterial growth more in combination with rifampicin meaning bacteria showed lower antibiotics resistance against rifampicin (FIG. 16-21).

### High-Performance Liquid Chromatography (HPLC) Analysis

Since catechins (C), EC, or EGCG may each inhibit microbial growth, their concentrations in different commercial teas were investigated by HPLC analysis. W_gt green tea contained the highest C content followed by H_gt green tea and P_ogt organic green tea and Y_gt green teas (FIG. 22). EGCG contents were correlated with inhibitory effects of teas with W_gt having the highest and H_gt slightly lower content. EC contents of W_gt green tea was lower than C_bt black tea, showing it might not have a direct relationship with bacterial inhibition. P_obt organic black tea's EGCG content was relatively higher compared to C_bt black tea. —The EC content was the lowest-in organic black tea (P_obt).

### Field Emission Scanning Electron Microscope (FESEM) Imaging

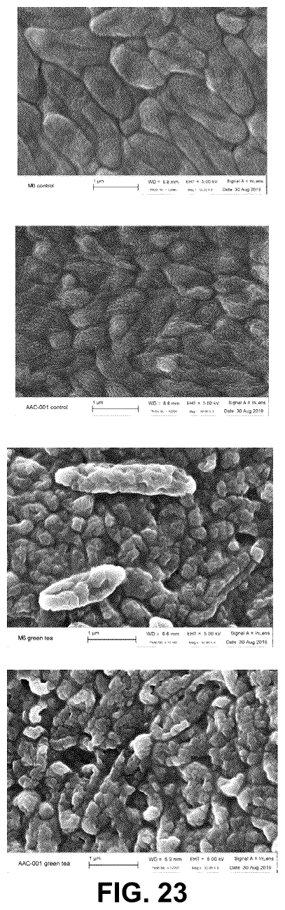

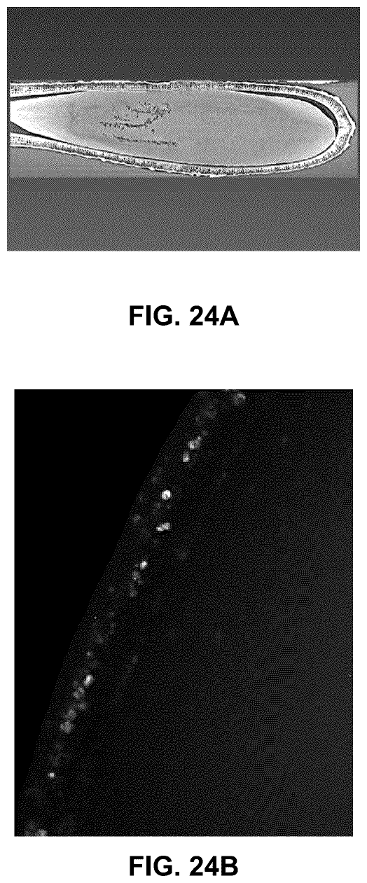

Effects of green tea treatment on A. citrulli integrity was assessed with-scanning electron microscopy. The images revealed disrupted cell wall structures on both M6 and AAC00-1 bacterial strains treated with Y_gt green tea. (FIG. 23) BFB disease can be transmitted to seeds from infected fruit tissue (pericarp infection) or to the embryo via infected pollen during fertilization. Embryo infected seeds provided by Dr. Ron Walcott created by pistil inoculation of flowers were x-rayed. Damage can be viewed in the embryo particularly along vascular tissue (FIG. 24A). No damage is associated with the periphery of the embryo or seed coat.

Pericarp infection was simulated by imbibing seed dried seeds in solutions of fluorescent tagged A. citrulli. Fluorescent microscopy revealed bacteria in the seed coat but not inside the embryo tissue. Embryos were free of fluorescence. Previous studies with Cucumis spp. seeds have shown that the single layer endosperm has suberized cell walls and forms a diffusion barrier around sensitive embryos. This layer of endosperm has apparently evolved to protect the sensitive embryo from alcohols and acids created during fruit tissue decomposition, which occurs as seeds are released into the environment during senescence (Yim and Bradford, 1998; Welbaum and Bradford, 1990a). This resilient osmotic barrier is such that migration of microbes like bacteria would be prevented. In the case of BFB transmission, this means that seed coat infection does not spread to the embryo and vice versa because such movement is blocked by the semipermeable endosperm layer protecting the embryo just below the seed coat. Interestingly, the endosperm tissue is not a barrier to water so only diffusion of large molecules and bacteria are blocked (Welbaum and Bradford, 1990a). Germination of these seeds does not occur until the endosperm envelope is enzymatically ruptured allowing radicle protrusion. (Welbaum et al., 1998; Welbaum and Bradford, 1990b).

### Experiments Using Infected Seeds and Tea Treatments

### QPCR Comparison

Results were inconclusive when comparing presence of bacteria especially at low concentrations on control seeds via qPCR, compared to the spiked positive control. Bacterial DNA was observed on green tea treated seeds especially on seeds that were inoculated with higher concentrations of bacteria.

### GFP Localization on Seed to Seedling Transmission Assays

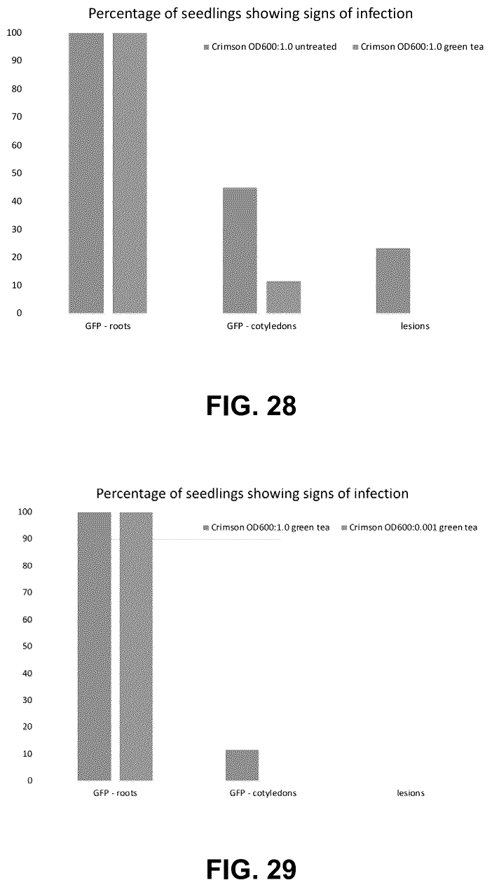

Only a small number of seedlings have shown water soaking like lesions when grown despite the high concentrations of inoculation and 90% relative humidity. Therefore, we used the GFP signal of the M6 strain tagged with GFP to localize the bacteria on the plant. The performed GFP signal detection on seedlings has shown apparent GFP in cotyledon tip lesion as well as cotyledon body and root. Whereas seedlings that are grown from Yamamotoyama green tea treated seeds has not shown any lesions. It was also observed that seeds treated with green tea showed very little or no GFP in the tip of the cotyledon as compared to the untreated seedlings (FIG. 29) as opposed to the untreated seedlings (FIG. 28).

### Application of Green Tea to Seed Lots

### Experimental

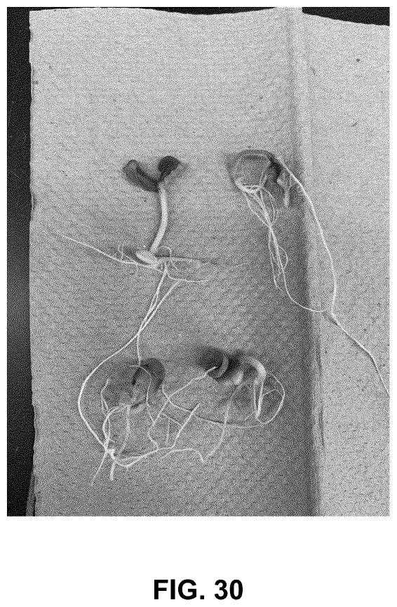

A commercial melon seed lot containing about 25% BFB infected seeds (FIG. 30) was provided. A preliminary grow-out experiment on blotter paper in boxes in an incubator confirmed that about 20% of three-week-old seedlings displayed classic systems of BFB early in development. This initial grow out was conducted on four replications of 25 seeds each incubated at 28° C., an optimal temperature for A. citrulli development.

A solution of green tea was prepared by boiling 6.5 g of air-dried green tea leaves in 300 mL of distilled stilled water. Leaves were filtered from the liquid in a Buchner Funnel with Whatman #1 filter paper. The optical density of the filtered tea stock solution was 2.1. The concentrated tea stock solution was stored in a refrigerator at 3° C. until the seeds were treated during the next two days. 250 seeds were treated in 150 mL of the green tea in a vacuum flask. Treated seeds were dried without rinsing and forced-air dried for 30 minutes at low heat and final dried in desiccator at 30 to 40% RH for a total drying time of at least 12 hours.

Four germination experiments were conducted. There were two controls. For the first control, 4 replications of 25 seeds each were planted untreated on two thicknesses of blotter paper hydrated with 16 mL of distilled water and incubated at 28° C. For the second control, seeds were vacuum infiltrated in distilled water for 5 hours, force-air dried, and final dried in a desiccator for 12 h and then germinated in 4 replications of 25 seeds each on blotter paper as described above at 28° C.

Two green tea treatments were germination tested. In the first, 4 replications of 25 seeds each of infected seeds were planted directly in plastic sandwich boxes on two thickness of germination blotter paper (Anchor Paper Company) in 22 mL of green tea without vacuum infiltration and incubated at 28° C. in dark to determine if green tea could control BFB without vacuum infiltration. Eight replications of dried tea-infiltrated seeds treated as described above, were germinated in boxes on blotter paper saturated with 16 mL of water at 28° C. Seeds were scored for germination daily for the first 10 days and assessed for BFB infection after 3 weeks.

### Results

Seeds were germinated at 28° C., the optimum growth temperature for BFB development in dark. After germination, seeds were moved to a growth chamber with high light intensity to promote normal melon seedling development. Control untreated infected seeds germinated fastest and to the highest percentage. However, 27% of untreated control seeds showed BFB symptoms (FIG. 30). Seeds vacuum infiltrated in water as a control before drying and germination testing performed poorly and were heavily infested with mold (Table 1, FIG. 3). Because of this secondary infection, it was impossible to accurately assess the percentage of BFB infected seeds for this treatment, although no BFB symptoms were detected in the few healthy seedlings produced (FIG. 3, Table 4). Seeds vacuum infiltrated with green tea germinated slower to a slightly lower percentage than the untreated control (Table 4). Compared to the vacuum infiltration water control, fungal disease was noticeably less in seeds vacuum infiltrated in green tea prior to germination. However, some fungi were present in green tea treated seeds, and a few seedlings died from non-BFB symptoms. Green tea infiltrated seeds had no seedlings that showed BFB symptoms compared to 27% for untreated seeds (Table 4). Untreated seeds incubated directly in green tea solution had lower final percentages and germinated more slowly than untreated seeds or seeds vacuum infiltrated with green tea (Table 4).

TABLE 4
Germination results for all treatments and percentage of BFB infection

| | | Germination | | |
|---|---|---|---|---|
| | Replications | (radicle | Mean time to | |
| | of 25 seeds | emergence) | Germination | Bacterial fruit |
| Treatment | each | (%) | (days) | blotch (%) |
| Infected seed | 4 | 96 | 5.9 | 27 |
| control | | | | |
| germinated in | | | | |
| water on blotters | | | | |
| without treatment | | | | |
| infected seeds | 4 | 66 | 7.1 | not determined |
| vacuum infiltrated | | | | because of |
| in water, dried | | | | extensive fungal |
| germinated | | | | disease infection |
| infected seeds | 4 | 84 | 7.3 | 0, some fungal |
| germinated | | | | infection |
| directly in green | | | | complicated |
| tea solutions | | | | assessment |
| vacuum infiltration | 8 | 92 | 6.8 | 0, some fungal |
| green tea, dried, | | | | infection |
| germinated | | | | complicated |
| | | | | assessment |

### Discussion

Green, compared to black tea, was a stronger inhibitor A. citrulli in culture. However, there was significant variation in the inhibition exhibited by different commercial green tea brands. Some brands were stronger inhibitors of A. citrulli than others. For example, the H_gt brand of green tea inhibited A. citrulli growth in culture by approximately 86%. At 10% green tea solutions based on OD390 2.0 and 4.0 H_gt and W_gt green tea completely inhibited bacterial growth even for the highest bacterial concentration tested, respectively (FIG. 10). Variation among effectiveness among green tea brands could be due to differing tea processing methods, genotypes, or growing environments. To test whether pesticide residues were responsible for antimicrobial properties, organic teas were included in some tests. Organic teas did not show reduced inhibition of A. citrulli in culture, providing evidence that pesticide contamination was not responsible for antimicrobial properties. This suggests some brands of green tea would make effective seed treatments against BFB disease. Rather than treat seeds with liquid green tea, powdered tea leaves or dry extracts containing active inhibitors could be added as a seed coating to improve the consistency of tea inhibition of A. citrulli.

Green and black tea are made from leaves of Camellia sinensis that are processed differently. For green tea, leaves are harvested, quickly heated either by pan firing or steaming, and dried to prevent excessive oxidation that would break down flavonoids. Black tea leaves are harvested, oxidized, heat-processed, and dried. During oxidation, many compounds are degraded altering their chemical profile turning leaves dark brown to black and giving the tea its name. So black tea is higher in caffeine and tannins but lower in flavonoids. Tannins from black tea have antibacterial properties but were ineffective against BFB.

Green tea flavonoid catechins are converted to theaflavins in the additional tea processing steps to make black tea. However, analysis of green tea components showed that catechins are likely more antimicrobial than theaflavins based on the greater efficacy of green tea compared to black tea (FIG. 2). Tea catechins play a significant role inhibiting A. citrulli (FIG. 4 & 8). Both catechins (Qais 2019) and caffeine (Norizan 2013) inhibit quorum sensing. Caffeine alone was not inhibitory, whereas catechin was strongly inhibitory of A. citrulli. Additionally, QS mutants showed ˜7% and ˜6% less growth (95% confidence level) compared to the wild-type AAC00-1, respectively, when grown with catechin and caffeine (Supp. FIG. 11). This suggests that QS alone was not solely responsible for green tea's antagonistic effect, but it did play a role.

Contents of EGCG and C were higher in H_gt and W_gt green teas, suggesting they are responsible for A. citrulli inhibition. H_gt showing was a more efficient inhibitor at lower optical densities compared to W_gt possibly because of its higher EC content. Therefore, we conclude that C, EC, and EGCG all play a role in inhibiting bacterial growth. Despite EGCG being correlated with the inhibitory properties of teas, the EC comparison showed multiple compounds inhibited of A. citrulli. Other green tea polyphenols such as ECG may be involved as well.

Green tea increased susceptibility of rifampicin resistant bacteria to the antibiotic. Cotreatment with antibiotics and green tea reduced growth 13% (95% statistical confidence) (FIG. 15-21). A previous study has suggested this synergistic effect was due to EGCG (Haghjoo 2013).

Cell wall damage, consistent with earlier findings with green tea, were visualized with FESEM (Liu 2017). Cell wall damage could be related to EGCG and maybe other green tea polyphenols. Green tea's effect on cell wall structure appears to be a major reason for inhibition of A. citrulli.

Treating seeds with GFP-tagged A. citrulli was a practical way to visualized bacteria during seed to seedling transmission. The majority of BFB contaminated seed lots are infected via seed contact with the pericarp. Cucurbit seeds coats naturally have air pockets, so vacuum infiltration was selected to ensure green tea could penetrate the porous seed coat and contact all A. citrulli. Seeds were incubated in A. citrulli solutions to simulate pericarp infection and then treated with green tea by vacuum infiltration. The promising inhibition of A. citrulli by green tea treatments of infected seeds suggest its potential. Green tea treatment did not cause any negative effects on seed quality.

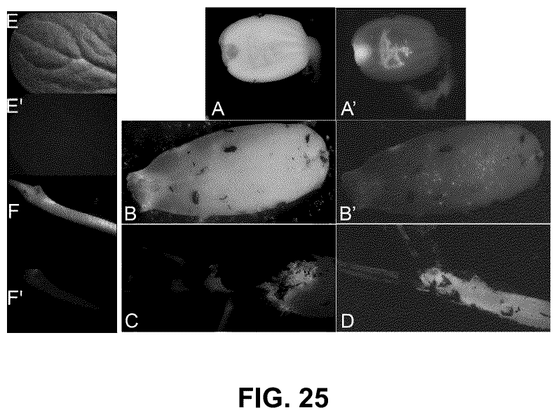

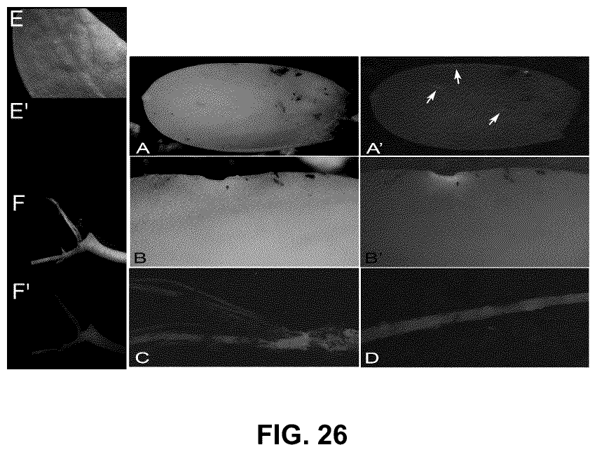

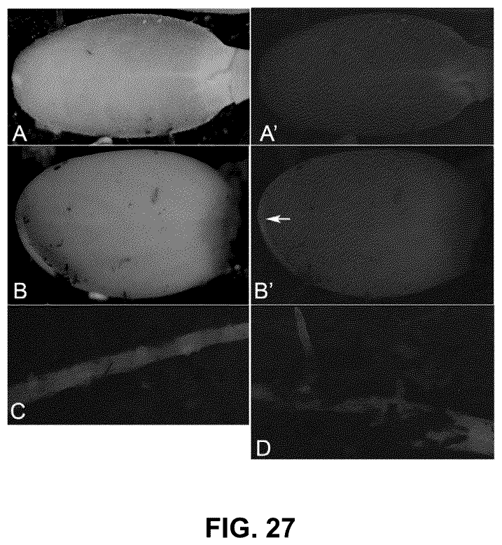

GFP visualization on inoculated melon and watermelon seeds showed clear differences between ‘Hales Best Jumbo,’ and ‘Crimson Sweet’, respectively (FIG. 24-25). Since M6 is a group-I strain of A. citrulli and was reported to show pathogenicity to both melon and watermelon, melon ‘Hales Best Jumbo’ could be showing some level of disease resistance to A. citrulli group-I strain M6. Even though Y_gt green tea was less effective than other green tea brands, Y_gt effectively reduced (OD₆₀₀:1.0) or completely inhibited (OD₆₀₀:0.001) the GFP signal on the cotyledons of infected seeds (FIG. 25-27). GFP fluorescence on roots could be due to autofluorescence as observed on the negative control. Our qPCR results showed that the bacteria were not simply washed off by green tea treatment.

Seed transmission of BFB can occur from pericarp or embryo infection. The two types of infection are fundamentally different. X-ray analysis showed evidence of BFB infection inside embryo tissue (FIG. 24A). It is questionable that green tea treatment would be effective again embryo infection. There was no evidence of BFB moving outside the embryo in x-ray images of infected seeds.

Imbibing dried seed in solutions of fluorescent tagged A. citrulli to simulate pericarp infection showed bacteria concentrated in the seed coat (FIG. 24B). Embryos were free of fluorescence after this treatment. Green tea would likely contact and inhibit BFB bacteria on the seed coat than deep in the embryo particularly when vacuum infiltration is used. Previous studies with Cucumis spp. have demonstrated that a single layer of endosperm with suberized cell walls protects sensitive embryos by forming a barrier to molecular diffusion. This unique adaptation of endosperm tissue has likely evolved over time to protect embryos from harsh breakdown products of fruit tissue decomposition, which occurs as seeds are released during fruit senescence (Yim and Bradford, 1998; Welbaum and Bradford, 1990a). This resilient osmotic barrier is such that movement of macromolecules like C, EC or ECGC would be blocked by fully formed intact endosperm tissue and could not enter the embryo. FIG. 24B shows that the endosperm is also a barrier to fluorescent tagged BFB. In the case of BFB transmission, this means that seed coat infection does not spread to the embryo and vice versa because such movement is blocked by the single-cell endosperm layer just below the seed coat. Interestingly the endosperm tissue is not a barrier to water so only diffusion of large molecules and bacterial are blocked (Welbaum and Bradford, 1990a). This means that green tea treatment would be anticipated to be most effective against seed coat or pericarp infection. Protective endosperms exist in many seeds from the families Cucurbitaceae, Asteraceae, and Solanaceae. In seeds without such barriers, green tea treatments may be more effective against bacterial pathogens residing in the embryo.

In conclusion, green tea and its polyphenols have the potential to reduce or completely diminish bacterial growth on culture and on pericarp (seed coat) infected seeds depending on the concentration and brand of green tea and the magnitude of infection. Therefore, green tea or a mixture of its polyphenols have the potential to be a commercially viable seed treatment against A. citrulli and possibly other seed transmitted plant pathogens.

### Soil Studies

To evaluate whether tea extract (HPGT) can reduce A. citrulli populations in soil, we conducted a soil-based growth curve assay. All experiments to assess A. citrulli growth in soil were conducted using PRO-MIX® is a general-purpose, peat-based growing medium formulated with a base of sphagnum peat moss and perlite. PRO-MIX® potting soil was first autoclaved, and 1 gram of sterilized PRO-MIX® was placed in 50 ml centrifuge tubes. A 3 ml bacterial suspension (OD600=0.08) and 500 μl of green tea extract (HPGT) or water (as a control) were added to soil in each tube. Tubes were maintained in a growth chamber set at 28° C./26° C. Bacterial populations in the soil were measured at 0 and 2 days post-incubation.

To determine bacterial populations, the soil mixture was resuspended in 10 mM MgCl₂, serially diluted, and plated onto Luria-Bertani broth (LB) culture medium containing carbenicillin (50 μg/ml), to which A. citrulli is naturally resistant. Colony-forming units (CFU) were counted 3 days after plating.

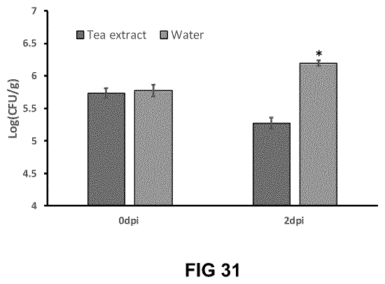

As shown in FIG. 31 below, at the initial 0-day starting point, the bacterial populations in soil treated with either water or tea extract were comparable. However, after 2 days of incubation, soil treated with the green tea extract had a significantly reduced A. citrulli bacterial population compared to the water control. Based on these replicated results, we conclude that treating soil contaminated with A. citrulli using green tea extract can reduce bacterial populations, potentially mitigating bacterial fruit blotch (BFB) disease in soil and reduce its transmission to plants.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

Bikels-Goshen, T., E. Landau, S. Saguy, and R. Shapira. 2010. Staphylococcal strains adapted to epigallocathechin gallate (EGCG) show reduced susceptibility to vancomycin, oxacillin and ampicillin, increased heat tolerance, and altered cell morphology. International Journal of Food Microbiology 138: 26-31. https://doi.org/10.1016/j.ijfoodmicro.2010.01.011.
Brackman, G., Defoirdt, T. Miyamoto, C. Bossier, P. Van Calenbergh, S., Nelis, H. and Coenye, T. 2008. Cinnamaldehyde and cinnamaldehyde derivatives reduce virulence in Vibrio spp. by decreasing the DNA-binding activity of the quorum sensing response regulator LuxR. BMC Microbiology 8: 149. https://doi.org/10.1186/1471-2180-8-149.
Choi O., Cho S. K. and Kim J. 2016. Biological evaluation of 32 different essential oils against Acidovorax citrulli, with a focus on essential oil Cinnamomum verum. African Journal Biotechnology 15: 76.
Dutta, B., Avci, U. T. K. U., Hahn, M. G., & Walcott, R. R. 2012. Location of Acidovorax citrulli in infested watermelon seeds is influenced by the pathway of bacterial invasion. Phytopathology 102:461-468.
Dutta, B., Schneider, R. W., Robertson, C. L. and Walcott, R. R. 2016. Embryo localization enhances the survival of Acidovorax citrulli in watermelon seeds.” Phytopathology 106: 330-338. https://doi.org/10.1094/phyto-09-15-0232-r.
Giovanardi, D., Sutton, S. Stefani, E. and Walcott, R. 2018. Factors influencing the detection of Acidovorax citrulli in naturally contaminated cucurbitaceous seeds by PCR-based assays. Seed Science and Technology 46: 93-106. https://doi.org/10.15258/sst.2018.46.1.09.
Gupta, D. A., Bhaskar, D. J., Gupta, R. K., Karim, B., Jain, A., and Dalai, D. R. 2014. Green tea: a review on its natural antioxidant therapy and cariostatic benefits. Biol. Sci. Pharm. Res. 2: 8-12. http://journalissues.org/abstract/gupta-et-al/.
Ha, Y., A. Fessehaie, K. S. Ling, W. P. Wechter, A. P. Keinath, and R. R. Walcott. 2009. Simultaneous detection of Acidovorax avenae subsp. citrulli and Didymella bryoniae in cucurbit seedlots using magnetic capture hybridization and real-time polymerase chain reaction. Phytopathology 99: 666-78. https://doi.org/10.1094/phyto-99-6-0666.
Haghjoo, Bobak, Lee H Lee, Umme Habiba, Hassan Tahir, Moe Olabi, and Tin-Chun Chu. 2013. The synergistic effects of green tea polyphenols and antibiotics against potential pathogens. Advances in Bioscience and Biotechnology 4: 959.
Hopkins, D. L., Thompson, C. M., Hilgren, J. and Lovic, B. 2003. Wet seed treatment with peroxyacetic acid for the control of bacterial fruit blotch and other seedborne diseases of watermelon. Plant Disease 87: 1495-1499, https://doi.org/10.1094/PDIS.2003.87.12.1495.
Jigisha, A., Nishant, R., Navin, K., and Pankaj, G. 2012. Green tea: a magical herb with miraculous outcomes. Int. Res. J. Pharm. 3: 139-148. http://www.irjponline.com/admin/php/uploads/1083_pdf.pdf.
Kubota, M., Hagiwara, N. and Shirakawa, T. 2012. Disinfection of seeds of cucurbit crops infested with Acidovorax citrulli with dry heat treatment. Journal of Phytopathology 160: 364-368. https://doi.org/https://doi.org/10.1111/j.1439-0434.2012.01913.x.
Leung, L. K., Y. Su, R. Chen, Z. Zhang, Y. Huang, and Z. Y. Chen. 2001. Theaflavins in black tea and catechins in green tea are equally effective antioxidants. Journal Nutrition 131: 2248-51. https://doi.org/10.1093/jn/131.9.2248.
Liu, X., Shen, B. Du, P. Wang, N. Wang, J. Li, J. and Sun, A. 2017. Transcriptomic analysis of the response of Pseudomonas fluorescens to epigallocatechin gallate by RNA-seq. PloS One 12: e0177938-e0177938. https://doi.org/10.1371/journal.pone.0177938.
Navarro-Martinez, M. D., Navarro-Perán, E. Cabezas-Herrera, J. Ruiz-Gómez, J. Garcia-Cánovas, F. and Rodríguez-López, J. N. 2005. Antifolate activity of epigallocatechin gallate against Stenotrophomonas maltophilia. Antimicrobial agents and chemotherapy 49: 2914-2920. https://doi.org/10.1128/AAC.49.7.2914-2920.2005.
Nazzaro, F., Fratianni, F. and Coppola, R. 2013. Quorum sensing and phytochemicals. International Journal of Molecular Sciences 14: 12607-12619. https://www.mdpi.com/1422-0067/14/6/12607.
Niu, C., S. Afre, and E. S. Gilbert. 2006. Subinhibitory concentrations of cinnamaldehyde interfere with quorum sensing. Lett Appl Microbiol 43: 489-94. https://doi.org/10.1111/j.1472-765X.2006.02001.x.
Norizan, Siti Nur Maisarah, Wai-Fong Yin, and Kok-Gan Chan. 2013. Caffeine as a Potential Quorum Sensing Inhibitor. Sensors 13: 5117-5129. https://www.mdpi.com/1424-8220/13/4/5117.
Qais, F. A., M. S. Khan, and I. Ahmad. 2019. Broad-spectrum quorum sensing and biofilm inhibition by green tea against gram-negative pathogenic bacteria: Deciphering the role of phytocompounds through molecular modelling. Microbial Pathology 126: 379-392. https://doi.org/10.1016/j.micpath.2018.11.030.
S̆ilarová, P., L. C̆eslová, and M. Meloun. 2017. Fast gradient HPLC/MS separation of phenolics in green tea to monitor their degradation. Food Chem 237: 471-480.
Sowell, G. and Schaad, N. W. 1979. Pseudomonas pseudoalcaligenes subsp. citrulli on watermelon seed transmission & resistance of plant introductions. Plant Disease Reports 63: 437-441.
Toda, M., Okubo, S. Hiyoshi, R. and Shimamura, T. 1989. The bactericidal activity of tea and coffee. Letters in Applied Microbiology 8: 123-125. https://doi.org/https://doi.org/10.1111/j.1472-765X.1989.tb00255.x.
Wall, G. C. 1989. Control of watermelon fruit blotch by seed heat-treatments. Phytopathology 79: 1191.
Welbaum, G. E., & Bradford, K. J. 1990a. Water relations of seed development and germination in muskmelon (Cucumis melo L.) IV. Characteristics of the perisperm during seed development. Plant Physiology 92:1038-1045.
Welbaum, G. E., & Bradford, K. J. 1990b. Water relations of seed development and germination in muskmelon (Cucumis melo L.) V. Water relations of imbibition and germination. Plant Physiology 92:1046-1052.
Welbaum, G. E., Bradford, K. J., Yim, K. O., Booth, D. T., & Oluoch, M. O. 1998. Biophysical, physiological and biochemical processes regulating seed germination. Seed Science Research 8:161-172.
Willems, A., Goor, M., Thielemans, S., Gillis, M., Kersters, K., & De Ley, J. 1992. Transfer of several phytopathogenic Pseudomonas species to Acidovorax as Acidovorax avenae subsp. avenae subsp. nov., comb. nov., Acidovorax avenae subsp. citrulli, Acidovorax avenae subsp. cattleyae, and Acidovorax konjaci. International Journal of Systematic and Evolutionary Microbiology 42:107-119.
Yim, K. O., & Bradford, K. J. 1998. Callose deposition is responsible for apoplastic semipermeability of the endosperm envelope of muskmelon seeds. Plant Physiology 118:83-90.

1. A method for preventing or reducing a bacterial infection on a plant seed, the method comprising applying to the plant seed epigallocatechin-3 gallate, catechin, epicatechin, or any combination thereof.

2. The method of claim 1, wherein a mixture comprising epigallocatechin-3 gallate, catechin, and epicatechin is applied to the plant seed.

3. The method of claim 1, wherein the epigallocatechin-3 gallate, catechin, and epicatechin are pure or substantially pure.

4. The method of claim 1, wherein epigallocatechin-3 gallate, catechin, epicatechin, or any combination thereof is applied to the plant seed as a dry powder or as solution in water.

5. The method of claim 1, wherein catechin and epigallocatechin-3 gallate are applied to the plant seed, wherein the weight ratio of catechin to epigallocatechin-3 gallate is from about 2:1 to about 6:1.

6. The method of claim 1, wherein catechin and epicatechin are applied to the plant seed, wherein the weight ratio of catechin to epicatechin is from about 0.5:1 to about 10:1.

7. The method of claim 1, wherein epicatechin and epigallocatechin-3 gallate are applied to the plant seed, wherein the weight ratio of catechin to epigallocatechin-3 gallate is from about 0.5:1 to about 5:1.

8. The method of claim 1, wherein the plant seed is contacted with epigallocatechin-3 gallate, catechin, epicatechin, or any combination thereof by vacuum infiltration.

9. The method of claim 1, wherein the plant seed is contacted with a tea.

10. The method of claim 1, wherein the plant seed is contacted with green tea.

11. The method of claim 10, wherein the green tea has an optical density (OD₃₉₀) of from about 0.1 to about 10.

12. The method of claim 1, wherein the plant seed is further contacted with an antibiotic.

13. The method of claim 12, wherein the plant seed is sequentially contacted with epigallocatechin-3 gallate, catechin, epicatechin, or any combination thereof and the antibiotic or the plant seed is concurrently contacted with epigallocatechin-3 gallate, catechin, epicatechin, or any combination thereof and the antibiotic.

14. The method of claim 12, wherein the plant seed is contacted with a composition comprising water, epigallocatechin-3 gallate, catechin, epicatechin, or any combination thereof, and the antibiotic.

15. The method of claim 12, wherein the plant seed is sequentially contacted with green tea and the antibiotic or the plant seed is concurrently contacted with green tea and the antibiotic.

16. The method of claim 12, wherein the plant seed is contacted with a composition comprising green tea and the antibiotic.

17. The method of claim 12, wherein the antibiotic is rifampicin, streptomycin, or a combination thereof.

18. The method of claim 12, wherein the antibiotic has a concentration of about 10 μg/mL to about 1,000 μg/mL.

19. The method of claim 1, wherein the bacteria is a seedborne plant or human pathogen selected from the group consisting of Xanthomonas axonopodis pv. phaseoli (cause of common bacterial blight) and Pseudomonas syringae pv. phaseolicola (cause of halo blight), Xanthomonas campestris pv. campestris-cauliflower, and Xanthomonas euvesicatoria-pepper, Xanthomonas euvesicatoria, and Pseudomonas syringae pv. glycinea, Clavibacter michiganensis subsp. michiganensis, or Serratia marcescens.

20. The method of claim 1, wherein the bacteria is Acidovorax citrulli.

21. The method of claim 1, wherein bacterial infection is reduced by at least 50% when compared to the same plant seed where epigallocatechin-3 gallate, catechin, epicatechin, or any combination thereof is not applied to the plant seed.

22. The method of claim 1, wherein the plant seed comprises a fruit seed, a vegetable seed, or a seed for producing a plant for use in landscaping.

23. A plant seed produced by the method of claim 1.

24. A plant produced by a seed of claim 23.

25. A method for preventing or reducing a bacterial infection on a plant seed, the method comprising planting the seed in soil comprising epigallocatechin-3 gallate, catechin, epicatechin, or any combination thereof, wherein epigallocatechin-3 gallate, catechin, epicatechin, or any combination thereof is added to the soil before or after the seed is planted in the soil.

26. Soil comprising epigallocatechin-3 gallate, catechin, epicatechin, or any combination thereof, wherein epigallocatechin-3 gallate, catechin, epicatechin, or any combination thereof is added to the soil.

27. The soil of claim 26, wherein the soil is potting soil or topsoil.
